(19) United States
(12) Patent Application Publication
(10) Pub. No.: US 2024/0406215 A1
(43) Pub. Date: Dec. 5, 2024

(54) MULTIMEDIA STREAMING AND DEVICE ONBOARDING

(71) Applicant: Apple Inc., Cupertino, CA (US)

(72) Inventors: Erik R. Turnquist, Oakland, CA (US); Manasi Jahagirdar, San Jose, CA (US)

(73) Assignee: Apple Inc., Cupertino, CA (US)

(21) Appl. No.: 18/680,817

(22) Filed: May 31, 2024

Related U.S. Application Data
(60) Provisional application No. 63/470,742, filed on Jun. 2, 2023.

(51) Int. Cl. H04L 9/40

(52) U.S. Cl. CPC H04L 63/20; H04L 63/029; H04L 63/166

(57) ABSTRACT

Techniques are described herein for device onboarding. An example method can include receiving an identifier of an accessory device and a request to connect with the accessory device, via a first network, connectivity being restricted by a security mechanism of a second network. The method can further include transmitting a message to a management system of the second network to configure the security mechanism to permit connectivity between the user device and the accessory device based at least in part on the request and the identity of the accessory device. The method can further include receiving a message indicating that the management system has changed a configuration of the security mechanism to permit connectivity between the user device and the accessory device. The method can further include transmitting connectivity information for establishing a connection between the user device and the identified accessory device.

### CROSS-REFERENCE TO RELATED APPLICATIONS

This application claims the benefit of U.S. Provisional Application No. 63/470,742, filed on Jun. 2, 2023, which is incorporated by reference in its entirety.

Device onboarding is a process of introducing a device onto an existing infrastructure, such as a computing network. The infrastructure can validate the device and configure the device to be compatible with the infrastructure. Once the device is connected to the infrastructure, the device can communicate with other devices connected to the infrastructure and receive from and/or provide services to the infrastructure.

### BRIEF SUMMARY

A system of one or more computers can be configured to perform particular operations or actions by virtue of having software, firmware, hardware, and/or a combination of them installed on the system that, in operation cause the system to perform the actions. One or more computer programs can be configured to perform particular operations or actions by virtue of including instructions that, when executed by data processing apparatus, cause the apparatus to perform the actions.

One general aspect can include a computer-implemented method. The computer-implemented method can include receiving an identifier of an accessory device of a plurality of accessory devices and a request to connect with the accessory device. The request can be received by a computing system via a first network. A connectivity between the user device and the plurality of accessory devices via the first network can be restricted by a security mechanism of a second network. The computing system can transmit a message to a management system of a managed network to configure the security mechanism to permit connectivity between the user device and the accessory device based at least in part on the request and the identity of the accessory device. The computing system can identify the management system has changed a configuration of the security mechanism to permit connectivity between the user device and the accessory device. The computing system can transmit, to the user device and the accessory device, connectivity information for establishing a connection between the user device and the accessory device.

Another general aspect can include a computing system comprising a memory configured to store computer-executable instructions; and a processor configured to access the memory and execute the computer-executable instruction to perform the computer-implemented method.

Another general aspect can include a non-transitory computer-readable medium comprising computer-executable instructions that, when executed by one or more processors of a computing system, cause the computing system to perform the computer-implemented method.

### BRIEF DESCRIPTION OF THE DRAWINGS

FIG. 1 is an illustration of an example setting for device onboarding, according to one or more embodiments.

FIG. 2 is an illustration of an example management system, according to one or more embodiments.

FIG. 3 is an illustration of an example discovery broker server, according to one or more embodiments.

FIG. 4 is an illustration of example security mechanisms for a discovery broker, according to one or more embodiments.

FIG. 5 is a signaling diagram for an example discovery broker start up, according to one or more embodiments.

FIG. 6 is a signaling diagram for an example process for device onboarding, according to one or more embodiments.

FIG. 7 is a signaling diagram for an example process for device onboarding, according to one or more embodiments.

FIG. 8 is a signaling diagram for an example process for invalidating connectivity, according to one or more embodiments.

FIG. 9 is a signaling diagram for an example process for invalidating connectivity, according to one or more embodiments.

FIG. 10 is an illustration of onboarding with a captive portal token, according to one or more embodiments.

FIG. 11 is an illustration of onboarding with a captive portal token, according to one or more embodiments.

FIG. 12 is a signaling diagram for onboarding with a captive portal token according to one or more embodiments.

FIG. 13 is a process flow for device onboarding, according to one or more embodiments.

FIG. 14 is an illustration indicating accessibility for a user device, according to one or more embodiments.

FIG. 15 is a signaling diagram for onboarding with a captive portal token according to one or more embodiments.

FIG. 16 is an illustration of a process for exchanging keys, according to one or more embodiments.

FIG. 17 is an illustration of a process for exchanging keys, according to one or more embodiments.

FIG. 18 is an illustration of a process for exchanging keys, according to one or more embodiments.

FIG. 19 is an illustration of a process for exchanging keys, according to one or more embodiments.

FIG. 20 is an illustration of a process for exchanging keys, according to one or more embodiments.

FIG. 21 is an illustration of a process for exchanging keys, according to one or more embodiments.

FIG. 22 is an illustration of a process for communicating between devices, according to one or more embodiments.

FIG. 23 is a signaling diagram for an initial exchange of keys, according to one or more embodiments.

FIG. 24 is a signaling diagram for connecting with an accessory device, according to one or more embodiments.

FIG. 25 illustrates an example architecture or environment configured to implement techniques described herein, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Onboarding can involve connecting a device to a network. The network can include a set of devices that are configured to exchange information with one another. The onboarding process can help ensure that a device is properly authenticated, which can include verifying the identity of a device before granting access to the network.

The network can verify the identity of a device that is requesting access to the network. The network can use various authentication mechanisms, such as secure passwords or digital certificates, to prevent unauthorized access. In the instance that the network verifies the identity of the device, the network can use security policies to determine the device's access privileges, as to which network resources can be accessed by the device. The security policies can be configured during a network configuration and include configuring security mechanisms, such as encryption algorithms and firewalls, and other appropriate security mechanisms.

A device that can present the appropriate security credentials, such as a secure password can be granted access to the network. Once the device is connected to the network, the device can communicate with other network devices and receive services via the network.

In a common onboarding scenario, a user can enter a home and the user's user device can detect a wireless network. For example, the home can include a local area network (LAN), such as the home's Wi-Fi network. In some instances, the home's Wi-Fi network can be restricted by a password. In these instance, the user device can detect the network, and the user can be prompted to enter a password. The user can enter the password on the user device, and the network can verify the password. Based on verifying the password, the network can grant the user device access to the home's Wi-Fi network. The user device can then access one or more services via the home's Wi-Fi network. The user device can further store the password in local memory for reconnecting with the home's Wi-Fi network. For example, in the event the user leaves the home, and then returns, the user device can reuse the password to reconnect without additional manual input from the user.

The device onboarding process can sometimes be different in commercial settings, such as a hospitality setting (e.g., a hotel, motel, hostel, cruise ship, short-term rental (e.g., for-rent-by-owner), or other hospitality setting). For example, a hotel can offer rooms for travelers, and large spaces for conventions and special events, such as weddings. The hotel can include devices in each space to improve the quality of the experience. In some instances, these devices are smart devices that a user can connect to with their own user devices. For example, a user can connect their user device with a smart device to stream music or video (e.g., from a streaming service or local memory).

However, the proprietor of the hospitality may only wish to offer access to certain user devices (e.g., while the user is a guest). Unlike in the home scenario in which the network devices are owned/managed by the user, the network devices in the hotel room can be provided by the hotel for use by guests. Additionally, the proprietor may wish to offer a user access to certain devices located on the premises, and restrict access to other devices located on the premises. For example, a hotel may desire to allow a user to access devices located in the user's hotel room, but restrict access to other devices located in other guest's hotel rooms.

Furthermore, in some instances, a proprietor may offer more than one network to its guests. A hospitality guest may have access to more than one of these networks. The proprietor may wish to enable a system that permits a guest to switch between available networks without having to manually enter credentials to switch from one network to another network.

The proprietor may further desire to enable a system that permits a guest to connect with a network without having to enter personally identifiable information. For example, it is common for a guest attempting to connect with a network to be routed to a captive portal page. The guest may be required to enter a name and a room number to connect to the network. The proprietor may desire to create a guest experience, in which the guest can connect to a network without entering personally identifiable information.

In addition, the proprietor may offer more than one accessory device in a room. Furthermore, the proprietor may wish to provide a good guest experience, which includes minimizing efforts made by the guests to connect accessory devices in the room. From time to time, a guest may wish to leave their room for a short period and then return. Furthermore prior to leaving the room, the guest may have been engaging in a streaming session using an accessory device. It may be beneficial to suggest that the guest reengage with the accessory device to continue the streaming session. Therefore, the proprietor may wish to have a system that can determine the guest has left the room for a while and retuned. A user device may be able to determine that the guest has returned and can provide the guest with a prompt to reengage with the accessory device. It should be appreciated that in some instances, the user device can provide a prompt with a suggestion to engage with an accessory device after the user device has initially scanned the QR code.

Embodiments described herein address the above-referenced issues by providing a techniques for onboarding devices onto a network in commercial settings. A discovery broker can be introduced that can manage connectivity between particular devices and any accessory devices that are provided for use by the user. The discovery broker can validate a user device requesting connectivity to an accessory device. The discovery broker can further transmit a request to a network management system to reconfigure a security mechanism to permit the user device to connect with the accessory device. The discovery broker can further acknowledge a grant of the user device's request to connect to the accessory device.

In addition, the embodiments described herein provide techniques for supporting a guest to switch between different networks. If a guest is connected to one network of a group of networks offered by a proprietor, the guest's device can switch to another network without having to manually reengage a connection process. In addition, the embodiments herein provide techniques for permitting accessory devices in a room to communicate pairing information with each other. Therefore, once a guest's device connects with one accessory device, the guest's device can connect with another accessory device in the room without having to undergo a manual connection process. Furthermore, the embodiments herein provide techniques for a guests device to determine that the device has been taken out of a room and then returned to the room. The device can further determine whether the device was previously paired with an accessory device. If the guest's device was previously connected with an accessory device, the guest's device can generate a suggestion for the guest to cause the device to reconnect with the accessory device. It should be appreciated that in some instances, the guest's device can provide a prompt with a suggestion to engage with an accessory device after the guest's device has initially scanned the QR code.

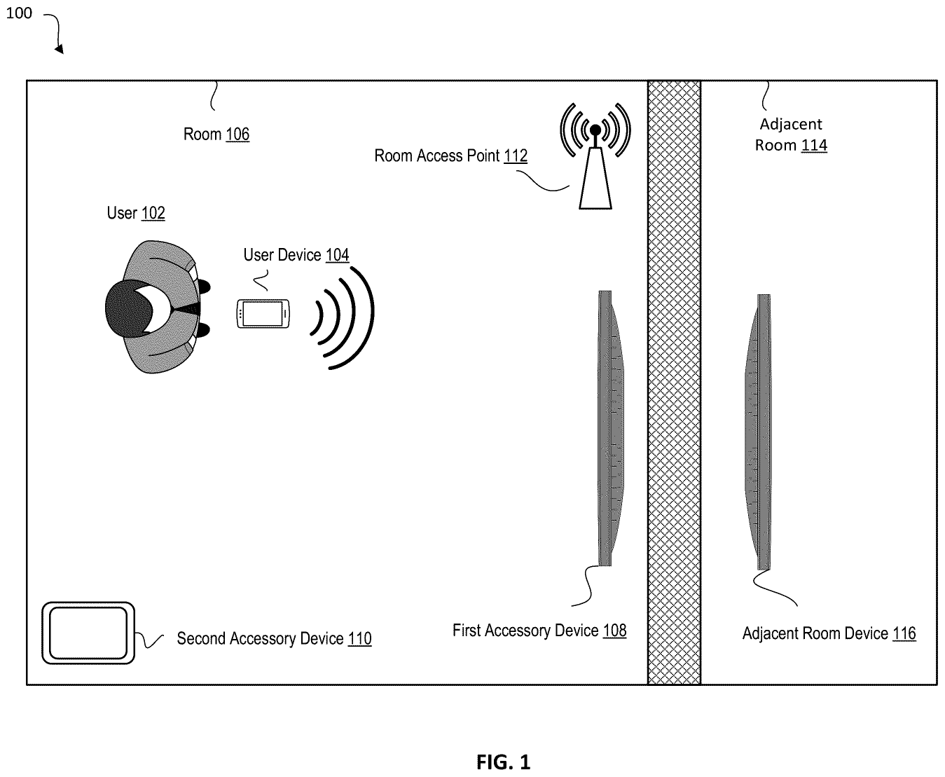

FIG. 1 is an illustration 100 of an example setting for device onboarding, according to one or more embodiments. A user 102 can be situated in a setting that includes one or more devices that can receive data from a user device 104 and present the content. As illustrated, the user 102 can be in a defined space, such as a room 106 in a hotel that the user has booked. The room 106 can include a first accessory device 108, such as a smart television, and a second accessory device 110, such as a tablet that has been provided by the hotel. Both the first accessory device 108 and the second accessory device 110 can be owned by the hotel and be designated for the room 106.

The room 106 can further include a networking device, such as a room access point 112 for providing wireless service for the user 102. Access points in a commercial setting can differ from access points in a residential setting. In a residential setting, an access point can generally provide wireless service to all or a substantial portion of a house. In a commercial setting, such as a hospitality setting, the access point 112 can be configured to provide more restrictive access to service. For example, a hotel can include a management system that can use a private network to implement security features for controlling connectivity to the hotel's devices (e.g., first accessory device 108 and the second accessory device 110). The security features can include providing separate networks for guest devices and hotel devices.

As illustrated in FIG. 1, the network management system can use the access point 112 to provide a public network for the user device 104 and the private network for the first accessory device 108 and the second accessory device 110. The private network can restrict incoming receptions from the user device 104 to the first accessory device 108 and the second accessory device 110 The private network can further restrict outgoing transmission from the first accessory device 108 and the second accessory device 110 to the user device 104. For example, the private network can include a firewall that restricts communication between the user device 104 and the first accessory device 108 and the second accessory device 110.

As further illustrated, the room 106 is separated by a shared wall from an adjacent room 114. Both the room 106 and the adjacent room 114 can be owned by the same entity, such as the hotel. An adjacent room device 116 can be arranged in the adjacent room 114 and access to the adjacent room device 116 can also be managed by the network management system.

In some instances, the user device 104 can communicate with one or more devices to route streaming content to these devices for presentation. For example, devices equipped with Apple Airplay can use the Airplay wireless communication protocol to communicate with another device and share content, such as video, photographs, and music. In an example scenario, a user may have a user device (e.g., an iPhone) and a smart television in their home. The user can use a user device feature, such as Airplay, to stream content from their user device to the smart television. This is often called “mirroring,” where the user device content is mirrored on the other device. Therefore, rather than watch a television program on their user device display, the user can watch the television program on the smart television. In this scenario, both the user device and the smart television may communicate over the same public network provided by a wireless router, and the public network may impose no restrictions on the user device and the smart television.

However, as indicated above, in some settings, such as a hospitality setting, communication with devices provided by a hotel is managed by a network management system. The hotel can manage communication between user devices and devices provided for guests to help manage the guest experience. For example, the user 102 can book the room 106, and the user 102 should be able to utilize the first accessory device 108 and the second accessory device 110 based on the booking. However, if the user 102 has not booked the adjacent room 114, the user 102 can be restricted from using the adjacent room device 116.

As an example, the user has booked the room 106 but the user has not booked the adjacent room 114. Furthermore, in this example, another party unrelated to the user 102 has booked the adjacent room 114. The user device 104 can be equipped with the capability to communicate with other devices, such as the first accessory device 108, the second accessory device 110, and the adjacent room device 116. Furthermore, each of the first accessory device 108, the second accessory device 110 and the adjacent room device 116 have the capability to receive and present content from the user device 104. In this example, if the network management system restricts communication between the user device 104 and the first accessory device 108 and the second accessory device 110 through the user's stay, the user's guest experience may be diminished. Furthermore, if the network management system permits the user device 104 to communicate with the adjacent room device 116 and stream content, the other party's guest experience may be diminished.

Therefore, the network management system can be configured to permit the user device to communicate with the first accessory device 108 and the second accessory device 110, but not the adjacent room device 116. In particular, the management system can enforce a security policy that employs one or more security mechanisms for restricting communication between a device communicating via the public network and both of the first accessory device 108 and the second accessory device 110. The security mechanism can include a fire wall that filters unauthorized communication to and from the first accessory device 108 and the second accessory device 110.

At some point during the user's stay in the room 106, the user may wish to use, for example, the first accessory device 108 to present content. The user 102 can use the user device 104 to communicate with the network management system via the access point 112 and transmit a request to connect with the first accessory device 108. For example, if the first accessory device 108 is a smart television, and the user wants to stream video content on the smart television.

Each of the first accessory device 108 and the second accessory device 110 can provide information to the user device 104 to be used for connectivity purposes. For example, the first accessory device 108 and the second accessory device 110 can be configured to display a QR code that provides connectivity information, including a Wi-Fi identifier, a Wi-Fi password, an accessory device identifier, and an accessory device pairing code. As described herein the user device 104 can receive the information through a QR code. However, it should be appreciated that the user device 104 can receive the same or similar information the various sources other than a QR code. For example, the user device 104 can receive the information from using near field communication (NFC) technology, a data payload included in a transmission from another device, a barcode, a light-based signal, and an audio signal, or other appropriate technology for delivering information.

In some embodiments, the user can choose to use the user device 104 to scan a first QR code or a second QR code. Each of the first QR code and the second QR codes can include information that (1) enables the user device 104 to connect to the first network (e.g., the QR code contains the public Wi-Fi network password) and (2) enables the user device 104 to pair with the first accessory device 108 and the second accessory device 110 (e.g., the QR code includes a pairing information for pairing with the accessory devices). The first QR code can be presented to the user device 104 via a smart television (e.g., first accessory device 108) home screen. The first QR code can provide information permit the user device 104 to connect with the first network and pair with the first accessory device 108 and the second accessory device 110, but not necessarily connect with the first accessory device 108 and the second accessory device 110. The second QR code can be presented to the user device 104 on, for example, a screen “curtain,” which can be screen on a device associated with for example Apple Airplay, a casting service, or other feature for presenting content on an accessory device. The second QR code can provide information for permitting the user device 104 to connect to the first network, pair with the first accessory device 108 and the second accessory device 110, and connect with the first accessory device 108 and the second accessory device 110.

The user device 104 can scan the QR code displayed on the home screen of the first accessory device 108. If the user device 104 is not already connected to Wi-Fi, the user device 104 can use the Wi-Fi password embedded in the QR code to connect to the public Wi-Fi network provided in the room 106 via the access point 112. The user device 104 can connect to the public Wi-Fi network in the background and without any manual input from the user 102. The user device 104 can further discover the management system and transmit a request to connect with the first accessory device 108. As described herein, an accessory device (e.g., the first accessory device 108 and the second accessory device 110) can be any device can connect with the user device 104. The request can include the first accessory device identifier, which the management system can use to validate the first accessory device 108. For example, the management system can validate that the first accessory device identifier is associated with an authorized accessory device. The management system can further validate that the first accessory device identifier is associated with an accessory device that is assigned to the room 106. In some instances, the first accessory device 108 and the second accessory device 110 are part of an accessory device group. In these instances, the QR code can include an accessory device PIN and a token (e.g., a discovery broker token). The user device can present the QR code information to the management system. The management system can provide accessory device group to the user device 104.

Based on the validation, the management system can adjust one or more security configurations to permit the user device 104 to communicate with the first accessory device 108. In some embodiments, the management system can further adjust the one or more security configurations to permit the user device 104 to communicate with both the first accessory device 108 and the second accessory device 110. For example, the management system can change the configuration of the firewall to permit the user device 104 to connect with the first accessory device 108. The management system can transmit a request grant back to the user device 104. In response to the receiving the grant, the user device 104 use the pairing code to connect with the first accessory device 108. The user 102 can then use the user device 104 to stream video content on the first accessory device 108.

As indicated above, the user device 104 can transmit the first accessory device identifier along with the request to connect, and the QR code can provide the pairing information for the first accessory device 108. Therefore, the management system can configure the security mechanism to permit the user device 104 to communicate with the first accessory device 108, while maintaining any restrictions toward communicating with accessory devices in other rooms, such as the adjacent room device 116 in the adjacent room 114.

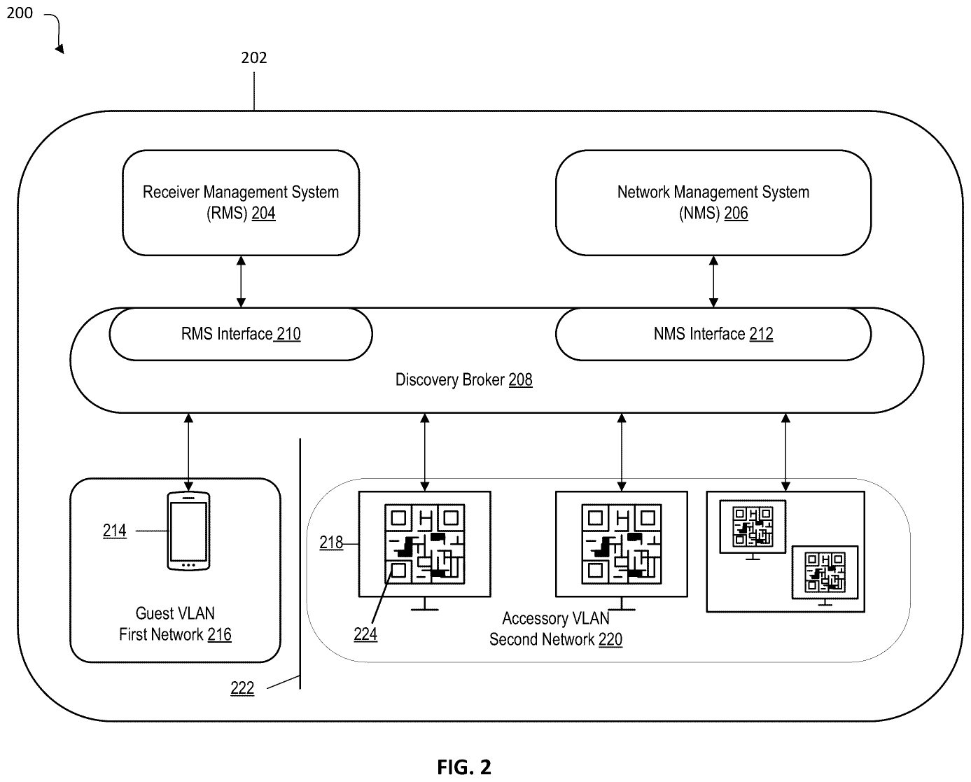

FIG. 2 is an illustration 200 of an example management system, according to one or more embodiments. The management system 202 can include a receiver management system (RMS) 204 that includes information for managing each accessory device on the premises. Each time that an enterprise (e.g., hotel) obtains an accessory device, the device can register with the RMS 204. The RMS 204 can permit the enterprise to perform a fleet-wide management of all of the devices (e.g., pushing software updates, managing usage). The RMS 204 can further include information indicating a location of each accessory device. For example, if the setting is a hotel, the RMS 204 can include a database that includes information on each device that indicates an accessory device identifier and a room to which the accessory device is assigned. In some instances, a room can include multiple accessory devices, such as a suite may include different televisions in different rooms. Some hotels may even offer personal computer laptops, or tablets along with a room. In these instances, the accessory devices may belong to a group assigned to the room and the database may include an accessory device group identifier.

The management system 202 can further include network management system (NMS) 206 for implementing security policies for the network. For example, the NMS 206 can configure the network to include a security mechanism to segment the network into multiple networks. The NMS 206 can further include respective security mechanisms to one or more of the multiple networks to prevent an unauthorized user device connected to one network from communicating with an accessory device connected to another network. The NMS 206 can further configure the networks to permit communication between authorized devices.

The management system 202 can further include a discovery broker 208 that can act as an intermediary between the RMS 204, the NMS 206, and user devices requesting network connection and connectivity with other accessory devices. The discovery broker 208 can communicate to the RMS 204 using an RMS interface 210. For example, the RMS interface 210 can include an application programming interface (API) that includes a set of definitions and protocols for communication between the discovery broker 208 and the RMS 204. The discovery broker 208 can communicate to the NMS 206 using an NMS interface 212. The NMS interface 212 can also include another API that includes a set of definitions and protocols for communication between the discovery broker 208 and the NMS 206. The discovery broker 208 can further use both the RMS interface 210 and the NMS interface 212 to respectively register with each of the RMS 204 and the NMS 206.

The discovery broker 208 can further broadcast identifying information to be received by user devices (e.g., the user device 214) over the first network 216. The user device 214, once connected to the first network 216, can discover the discovery broker 208 based on the broadcasted information. The discovery broker 208 can receive a communication from a user device 214 to connect with an accessory device. For example, the user device 214 can be the user device 104 from FIG. 1 and the accessory device 218 can be the first accessory device 108. The user device 214 can transmit the request via a first network 216 (e.g., a public Wi-Fi network). The request from the user device 214 can include an identifier for the accessory device 218. The user device 214 can be unable to connect with the accessory device 218 because the accessory device communicates over a second network 220, which is segmented from the first network 216. Furthermore, the NMS 206 can configure the second network 220 to have security mechanism 222 (e.g., a firewall) that prevents a user device (e.g., the user device 214) connected to the first network 216 from communicating with an accessory device (e.g., the accessory device 218) that is connected to the second network 220.

The discovery broker 208 can validate the user device 214 transmitting the request. For example, the discovery broker can determine, for example, whether the user device request is received in the proper format, whether the user device transmitted the accessory device identifier is in the proper format, and whether the user device requests connectivity with an accessory device that is associated with the room from which the user device request is being transmitted.

Based on validating the user device 214, the discovery broker 208 can transmit a request to the NMS 206 to allow the user device 214 to connect with the accessory device 218. The NMS 206 can have trust in the discovery broker 208, as the discovery broker 208 previously registered with the NMS 206. The NMS 206 can change a network configuration to permit the user device 214 to connect with accessory device 218. For example, the NMS 206 can reconfigure the security mechanism 222 to permit the user device 214 to connect with accessory device 218. As indicated above, in some instances, some rooms may include more than one accessory device, such as in an accessory device group. In these instances, the NMS 206 can change the configuration of a network security mechanism 222 to permit the user device 214 to connect with each accessory device. It should be appreciated that the user device 214 may still need to acquire the pairing code of each accessory device to establish a connection. However, the user device 214 can acquire the pairing code for each accessory device 218 before or after the NMS 206 reconfigures the security mechanism for connectivity with the accessory devices.

In some embodiments, the NMS 206 may be configured to permit a user device to connect to more than one network. For example, the NMS 206 may help manage a Passpoint network, which includes a protocol for enabling user devices to connect with different networks without undergoing an authentication process each time the user device switches networks. A group of networks can be associated and the user device can connect to each network that is part of the association without having to undergo the authentication process. In these instances, if the NMS 206 determines to change the security mechanism for one network, the NMS 206 changes the security mechanism for each associated network.

The user device 214 can be any device (e.g., smartphone, tablet, smart watch) can connect with the accessory device 218 as described herein. The user device 214 can stream audio and video media on another device (e.g., the user device 214 includes Apple Airplay). For example, a user can access a video sharing service on the user device 214. The user device 214 can further route the streaming data to an accessory device and stream the video sharing service content on the accessory device 218.

The user device 214 can connect and receive services from the management system 202 using a first network 216. Continuing with the hotel example above, a hotel guest can enter the hotel with their device, and the guest may wish to use their user device 214 to connect to the internet and stream content. The user device 214 can discover the first network 216 (e.g., a hotel's Wi-Fi network). The user device 214 can transmit a request to the management system to connect to the first network 216. The management system 202 can grant the request, and guest can browse the internet using their user device 214 for content.

The accessory device 218 can be any device (e.g., smart television, tablet, smart appliance, and smart speakers) that can connect with the accessory device 218 as described herein. The accessory device 218 can be a device that is owned by the enterprise (e.g., a hospitality enterprise, such as a hotel) that operates under the management system 202, and is provided to users to improve their experience. For example, the accessory device 218 can be the first accessory device 108 or the second accessory device 110 of FIG. 1. The accessory device 218 can connect to the management system 202 using the second network 220. The second network 220 can be a private network, such that even if user device 214 is connected to the first network 216 additional authorization may be required to connect to the second network 220. In each instance, that a new accessory device is added to the second network 220, the accessory device 218 can register with the management system 202, including the RMS 204 and the NMS 206. By registering with the RMS 204, the RMS 204 has an accurate accounting of each accessory device, each accessory device identifier, and each accessory device location on the premises. By registering with the NMS 206, the NMS 206 can provide any security mechanisms needed to secure the accessory device.

It can be seen from FIG. 2 that the first network 216 is segmented from the second network 220. It can further be seen that a security mechanism 22 can act as a barrier between the user device 214 and the accessory device 218. There can be practical reasons why an enterprise uses segmented networks. Consider a hotel that provides smart devices in guest rooms to enhance the guest experience. A guest should be able to access devices in their own rooms, but should be restricted from accessing devices in another guest's room. In addition to devices provided for the convenience of guests, the hotel can include other computing devices, such as reservation system servers, building infrastructure management servers, and database servers, that a guest should not be able to access. The discovery broker 208 permits the enterprise to maintain the security of the second network 220, while allowing the user to use their user device 214 to connect to the accessory device 218.

The accessory device 218 can include a display for displaying a QR code 224. The QR code 224 can include various information, such as a first network identifier, a first network passcode, and an accessory device identifier. The QR code 224 can further include a rotating pin code for establishing that the user device 214 is in visual proximity of the accessory device 218. The rotating pin code can periodically change (e.g., the pin code changes every 90 seconds). Therefore, even if the user device 214 had each other piece of QR code information, the user device 214 could not connect with the accessory device without the rotating pin. In some embodiments, the rotating pin can be associated with a service, such as Apple Airplay, which permits a user to stream content from the user device 214 on the accessory device 218.

In operation, the user device 214 can scan the QR code 224 from the accessory device display. The QR code 224 can be displayed on a home screen of the accessory device display, or the accessory device 218 can receive an input that causes the accessory device 218 to display the QR code 224. The user device 214 can discover one or more networks, and identify the first network using the first network identifier. The user device 214 can further request to connect to the first network 216 and present the first network passcode.

In some embodiments, the accessory device 218 can be configured to display a QR code 224, where the QR code 224 can provide information to connect to the first network 216 and pair with the accessory device 218. In some embodiments, the QR code 224 can include a standard-based QR code that can be presented on the display of the accessory device 218. The QR code 224 can include the first network connection information (e.g., service set identifier (SSID), network, Wi-Fi network password and other appropriate information), information to connect with the discovery broker 208 (e.g., discovery broker token), and information to pair with the accessory device 218 (e.g., accessory device PIN). In some embodiments, the QR code 224 can further include a captive portal token that can indicate that the user is associated with the room. As described below, This enables the user device 214 to connect with the network without the user having to input personally identifiable information, such as a name or a room number.

Upon connecting to the first network 216, the user device 214 can discover the discovery broker 208 and transmit a request to connect with the accessory device 218. The request can include the accessory device identifier and the rotating pin. The discovery broker 208 can use the accessory device identifier to validate the accessory device 218 and determine whether there may be additional accessory devices in the room. For example, the discovery broker 208 can communicate with the RMS 204 to determine if the accessory device belongs to a group of accessory devices in the room. If there are additional accessory device, the discovery broker may provide access to the additional accessory devices.

As indicated above, the discovery broker 208 can transmit a request to the NMS 206 to reconfigure the security mechanism 222 to permit the user device 214 to connect with the accessory device 218. The NMS 206 can transmit a message back indicating that the security mechanism has been changed to permit connectivity between the user device 214 and the accessory device 218. Upon identifying an indication that the security mechanism 222 has been reconfigured, the discovery broker 208 can transmit a request grant to the user device 214. The user device 214 can receive the request grant and then use the pairing code provided in the QR code 224 to connect with the accessory device 218. The user can then use their user device 214 to stream content on the accessory device 218 during their stay at the premises.

The RMS 202 can further regulate access to the accessory devices. For example, the RMS 202 can access information regarding the room booking information, including the end of the user's booked stay at the enterprise. Upon detecting that the user's booking has ended, the RMS 202 can transmit a notification to the NMS 206, the discovery broker 208, and the accessory device 218 that the booking has ended. Upon which, the NMS 206 can again reconfigure the security mechanism 222 to prevent the user device 214 from connecting with the accessory device 218. Furthermore, the connectivity information can be changed, for example, the pairing code can be changed and the QR code 224 can be changed to include the new pairing code. This can prevent a guest from having unauthorized access to the accessory devices.

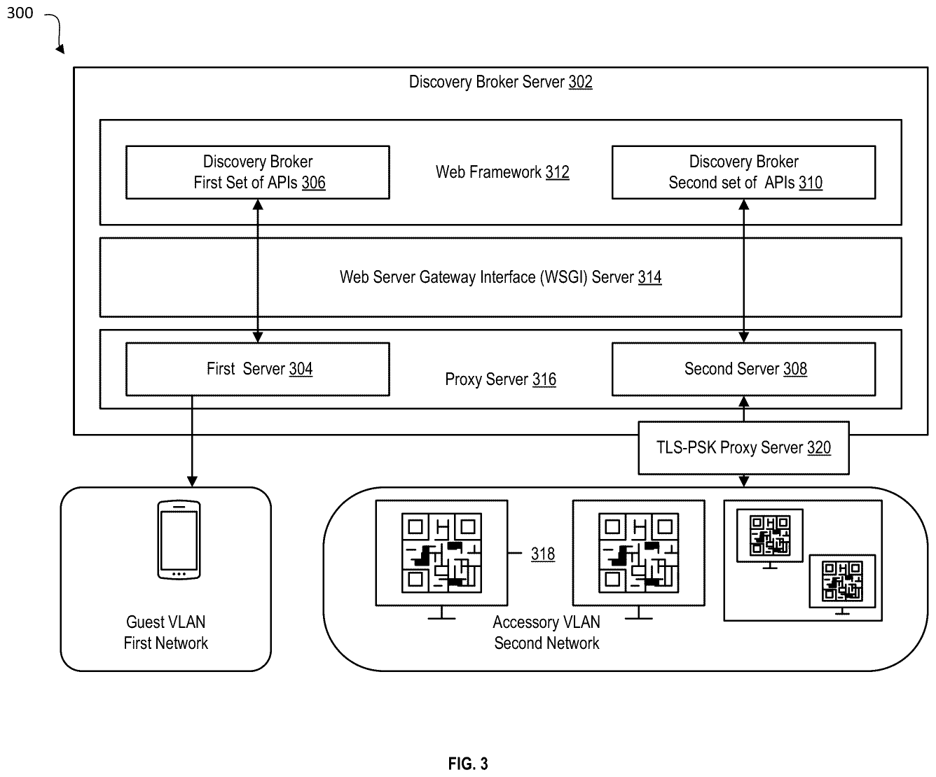

FIG. 3 is an illustration 300 of an example discovery broker server, according to one or more embodiments. A discovery broker server 302 can include a first server 304 used to access a first set of APIs 306, and a second server 308 used to access a second set of APIs 310. The discovery broker servers can be implemented as a web application (e.g., a Flask application) that includes a web framework 312 that is designed for integrating with the proprietor's system (e.g., the hotel system) and to support the development of web applications including services, resources, and APIs by the proprietor. The discovery broker servers can each use a web server gateway interface (WSGI) server 314, that implements a protocol for transmitting requests from a web server (e.g., the first server 304 and the second server 308) to a backend framework, such as the web framework 312. The WSGI server 314 can further pass back responses from the backend framework to the discovery broker servers.

The communication between the discovery broker servers and the web framework 312 can be managed by a proxy server that can store data in the cache, provide load balancing services, provide an additional security barrier for the web framework 312, permit secure communication between the accessory devices and the second server 308, and provide other appropriate functionality.

As illustrated, an accessory device 318 can communicate with the second server 308 via a transport layer security (TLS) pre-shared key (PSK) proxy server 320. The TLS-PSK proxy server 320 can implement a set of cryptographic protocols based on a set of pre-shared keys. In particular, the TLS-PSK proxy server 320 can execute a handshake process with the accessory device to exchange cryptographic keys to authenticate each other.

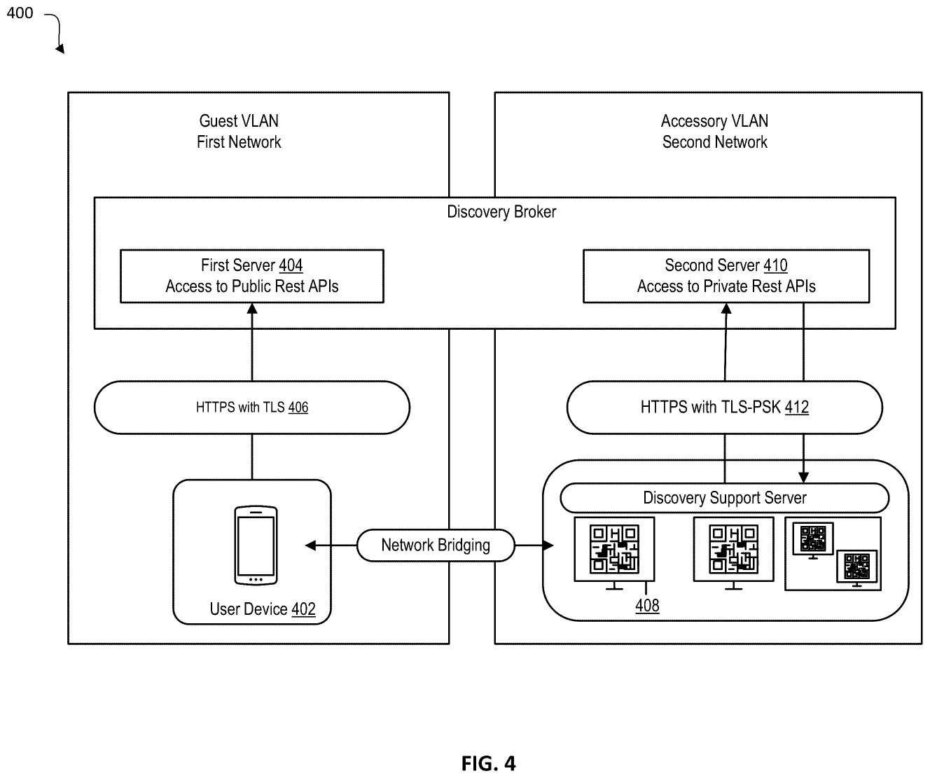

FIG. 4 is an illustration 400 of example security mechanisms for a discovery broker, according to one or more embodiments. As illustrated, the user device 402 can communicate with a first server 404 using a secure communication protocol. For example, the user device 402 and the first server 404 can communicate using a Hypertext Transfer Protocol Secure (HTTPS) in which the data is encrypted using a Transport Layer Security (TLS) protocol 406. At TLS connection between the user device 402 and the first server 404 is initiated with a TLS handshake. The user device 402 can transmit to the first server 404, the identity of the version of TLS that the user device 402 uses, a list of supported cipher suites (e.g., a set of encryption algorithms), and other TLS information. The first server 404 can use the TLS protocol version, select a cipher suite, and transmit a certificate to the user device 402. The certificate can be issued by the enterprise (e.g., hotel) and signed by a certificate authority known to the user device 402. The user device 402 can authenticate the certificate based on the certificate authority signature. Based on the authentication of the certificate, the user device 402 and the first server 404 can exchange cryptographic keys to be used to encrypt communications. The user device 402 and the first server 404 can establish a secure tunnel for communication, where data is encoded and decoded using the encryption algorithms and the cryptographic keys.

As further illustrated, the accessory device 408 can also communicate with the second server 410 using a secure communication protocol. For example, the accessory device 408 can communicate using a Hypertext Transfer Protocol Secure (HTTPS) in which the data is encrypted using a TLS-PSK protocol 412. For the TLS-PSK protocol 412, both the accessory device 408 and the second server 410 know the session key to be used during a secure session. The session key can be derived from a cryptographic key that has been pre-shared with both the accessory device 408 and the second server 410. To establish a secure communication session, the accessory device 408 can transmit a request for communication to the second server 410. The second server 410 can transmit a response message with an indication as to which pre-shared key is stored at the second server 410. The accessory device 408 can confirm that it has the same shared key, derive the session key using the shared key and transmit a message, encrypted using the session key, back to the second server 410 with an indication of the shared key. The second server 410 can receive the encrypted message, and retrieve the shared key based on the indication. The second server 410 can then derive the session key and decrypt the message from the accessory device 408. The accessory device 408 and the second server 410 can now establish a secure tunnel and communicate using encrypted messaging.

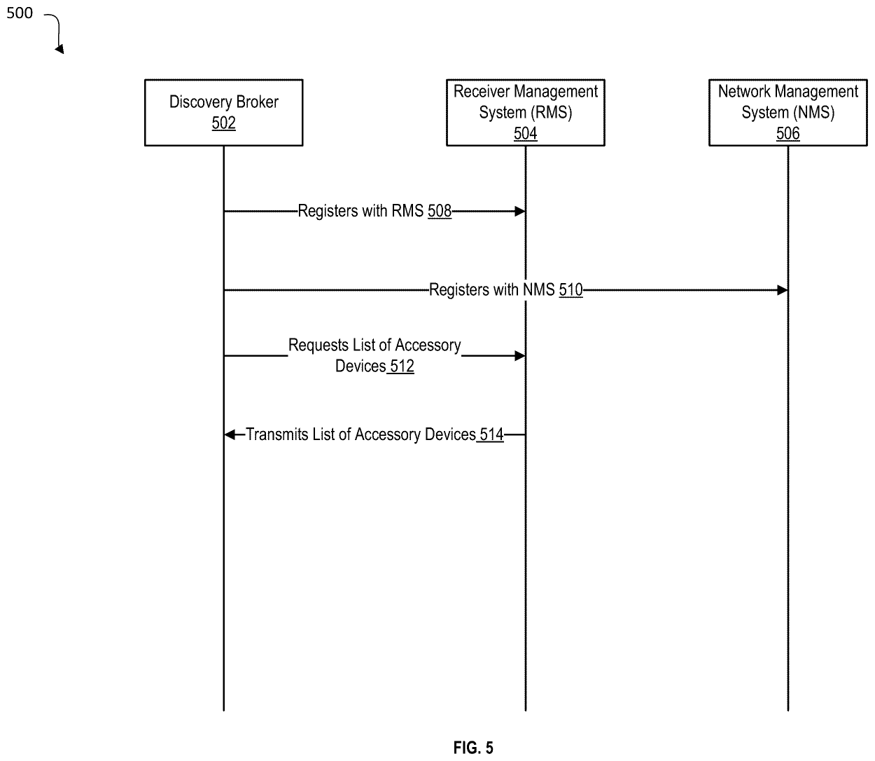

FIG. 5 is a signaling diagram for an example discovery broker start up, according to one or more embodiments. As illustrated, a discovery broker 502 can be in communication with an RMS 504 and an NMS 506. While the operations of process 500 are described as being performed by generic computers, it should be understood that any suitable device may be used to perform one or more operations of these processes. Process 500 (described below) is illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The discovery broker 502 can start up and initialize to begin operations. At 508, the discovery broker 502 can register with the RMS 504. The registration process can include the discovery broker 502 performing operations necessary to communicate with the RMS 504.

At 510, the discovery broker 502 can register and check in with the NMS 506. The registration process can include the discovery broker 502 performing operations necessary for the NMS to configure a security mechanism to permit a user device to communicate with an accessory device.

At 512, the discovery broker 502 can transmit a request to the RMS 504 for a list of accessory devices, accessory groups, and each accessory device within each accessory group.

At 514, the RMS 504 can transmit a response message, to the discovery broker 502, that includes the list of accessory devices, accessory groups, and each accessory device within each accessory group. It should be appreciated that as accessory devices are added, removed, or moved throughout a premises, the RMS 504 can modify and accessory group to add or delete an accessory device. For example, each time that a device is added to the second network, the accessory device registers with the RMS 504. The RMS 504 can add an accessory device to an accessory group based on information received during the accessory device's registration process. If, the RMS detects that an accessory device is no longer part of an accessory group, the RMS can remove the accessory from the list for that accessory group. At 514, the RMS can

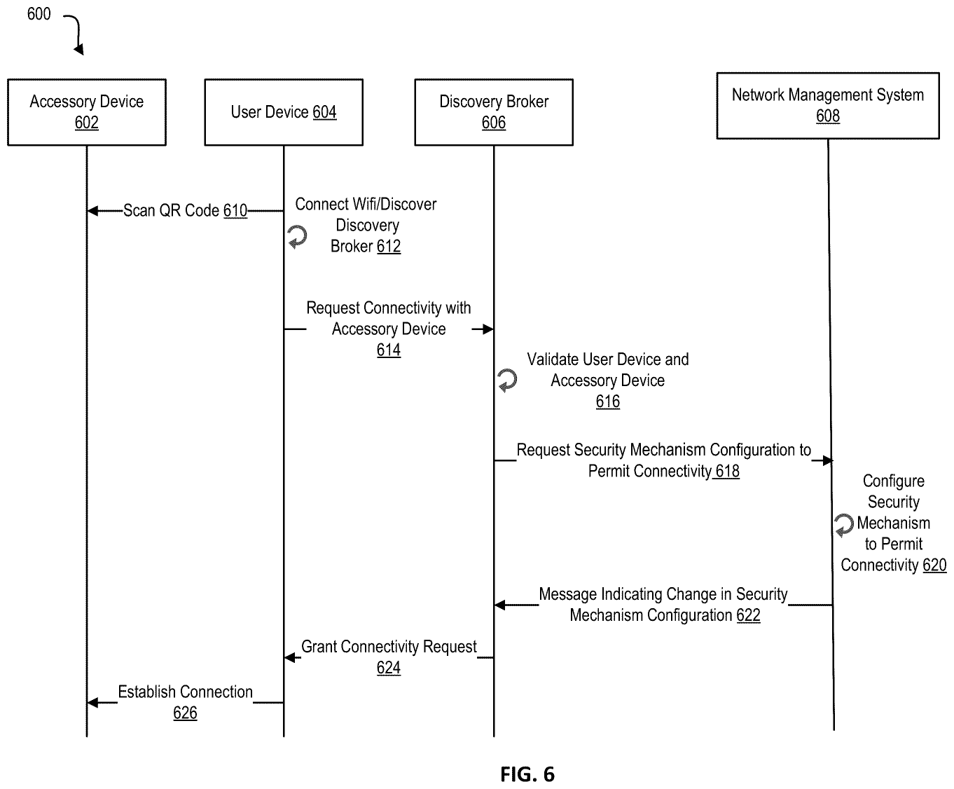

FIG. 6 is a signaling diagram 600 for an example process for device onboarding, according to one or more embodiments. As illustrated, an accessory device 602 can be in communication with a user device 694, a discovery broker 606 and an NMS 608. At 602, the user device 604 can scan a QR code displayed on the accessory device 602. The QR code can include information for connecting to a first network (e.g., a first network identifier and a network passcode), an accessory device identifier, and accessory device pairing information.

At 612, the user device 604 can, if not already connected, connect to the first network, such as a Wi-Fi network. The user device 604 can further discover the discovery broker 606. The discovery broker 606 can be configured to broadcast information indicating its presence over the first network. The user device 604 can receive a broadcast when connected to the first network and discover the discovery broker 606.

At 614, the user device 604 can transmit a request, to the discovery broker 606, to connect with the accessory device 602. The request can include the accessory device identifier and a user device identifier.

At 616, the discovery broker 606 can use the accessory device identifier and the user device identifier to validate the accessory device 602 and the user device 604. For example, the discovery broker 606 can have a list of accessory devices including accessory device identifiers. The discovery broker 606 can compare the received accessory device identifier with the list of accessory device identifiers to validate the accessory device. The discovery broker 606 can also validate the user device 604 based on the manner in which the user device presented the request. For example, the discovery broker 606 can determine whether the request is formatted properly, whether any extraneous information is included in the request, whether any information is missing from the request, and other appropriate considerations.

At 618, the discovery broker 606 can transmit a request to the NMS 608 to configure a security mechanism to permit the user device 604 to connect with the accessory device 602. The security mechanism, such as a firewall, which prevents communication between the user device 604 and the accessory device.

At 620, the NMS 608 can reconfigure the security mechanism to permit the user device 604 to connect with the accessory device 602.

At 622, the NMS 608 can transmit a message to the discovery broker 606. The message can include an indication that the NMS 608 has changed the configuration of the security mechanism to permit connectivity between the user device 604 and the accessory device 602.

At 624, the discovery broker 606 can transmit a grant of the request to connect with the accessory device 602 to the user device 604.

At 626, the user device 604 can use the accessory device pairing information from the QR code to establish a connection with the accessory device 602. The accessory device information can include a pairing pin for pairing with the accessory device 602.

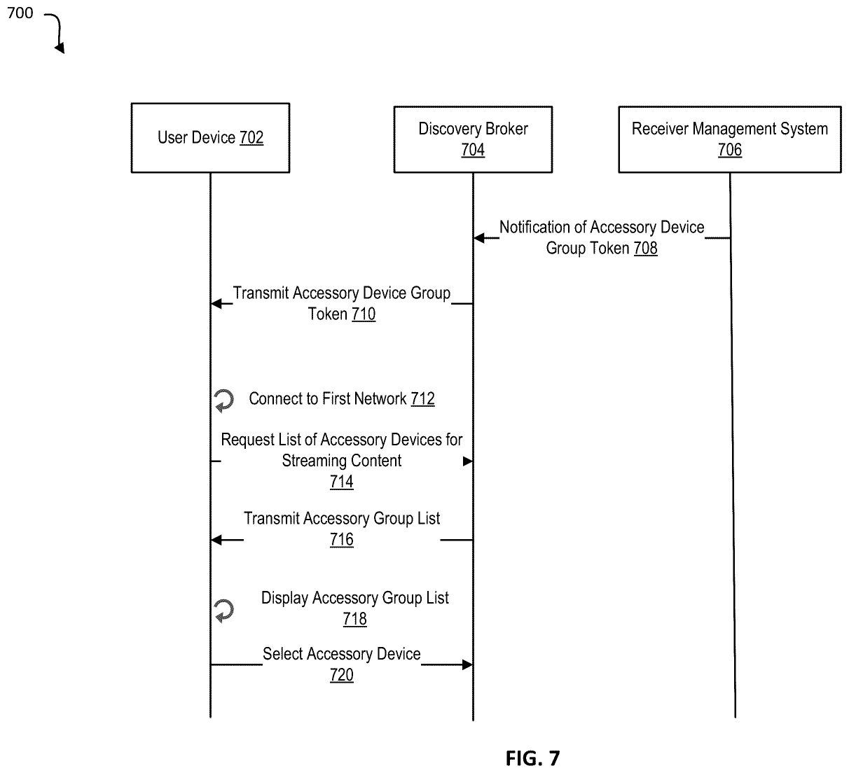

FIG. 7 is a signaling diagram 700 for an example process for device onboarding, according to one or more embodiments. As illustrated, a user device 702 can be in communication with a discovery broker 704 and an RMS 706. In some instances, an accessory device may not display a QR code providing connectivity information. In these instances, the discovery broker 704 can still facilitate a connection between the user device 702 and an accessory device.

At 708, the RMS 706 can transmit an accessory device group token to the discovery broker 704. The token can be a universally unique identifier (UUID) that is specific to a particular user (e.g., hotel guest) and can be valid for a determined period of time (e.g., the length of a hotel booking). The token can be used to provide access to accessory devices for presenting streaming content from the user device 702. The token can also authorize the user device 702 to display a list of available accessory devices that the user can select from.

At 710, the discovery broker 704 can transmit the token to the user device 702. At 712, the user device 702, if not already connected, can use the token to connect to a first network, such as a Wi-Fi network. For example, the user device 702 transmit a request to connect with the first network. The request can include the token. The request can be received by a server of the first network, and the server can authenticate the request based on the token.

At 714, the user device 702 can transmit the token back to the discovery broker 704 and requests a list of accessory devices.

At 716, the discovery broker 704 can transmit a list of accessory devices to the user device 702. For example, the discovery broker 704 can use the token to authenticate the request for the list of accessory device. Based on the authentication, the discovery broker can provide the list. The list of accessory device can be based on the user device transmitted the request. For example, if the user device is hotel guest's device, the list can include the accessory devices in the guest's hotel room.

At 718, the user device 718 can display the list of accessory devices. The display can include inputs for allowing the user to select which accessory device the user wishes to use to present the content.

At 720, the user device 702 can transmit an identity of the selected accessory device to the discovery broker 704. In some embodiments, the selection can cause a PIN code user interface (UI) on a display of the accessory device to be presented to the user. In other embodiments, the PIN code UI can be scannable, such as a scannable QR code. The process can then continue to step 610 of FIG. 6.

In some instances, a user may wish to switch from using the selected accessory device to another accessory device indicated in the list of accessory devices. In these instances, the user can select another accessory device from the list of accessory devices, and transmit the selection to the discovery broker 704. Rather than cause the newly selected accessory device to display a QR code and proceed to step 610 of FIG. 6, the discovery broker 704 can transmit a request to the NMS to reconfigure the security mechanism to permit the user device 702 to connect with the newly selected accessory device. The NMS can reconfigure the security mechanism to permit the user device 702 to connect with the newly selected accessory device. The user device 702 and the newly selected accessory device can then establish a connection.

In some instances, the user device (e.g., user device 104) can further provide recommendations for using an accessory device. This can arise in situations where the user device has received the list of accessory devices that the user can access (e.g., the list of accessory devices in the hotel room). The user device can detect that content is being viewed or about to be viewed on the user device. For example, a streaming service application (e.g., Apple TV application) has been initialized on the user device. The user device can review the list of accessory devices and determine that at least one accessory device can present the content. For example, the list of accessory devices includes a television. The user device can display a prompt asking the user whether they wish to view the content on the accessory device. If, the user indicates that the user does wish to watch the content on the accessory device, the user device can, if not already connected, connected with the accessory device and being to transmit the content for presentation to the accessory device.

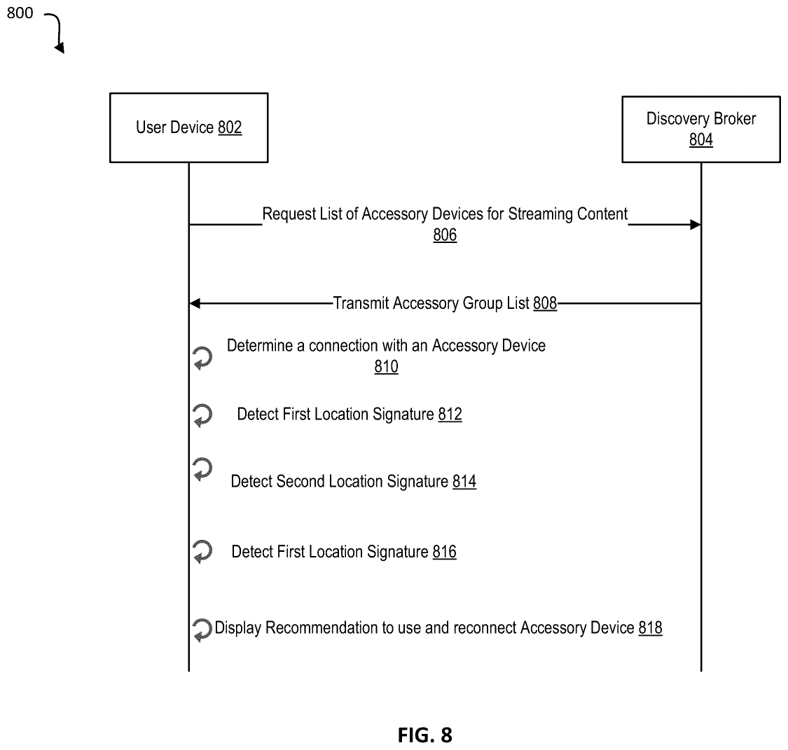

FIG. 8 is a signaling diagram for an example process for recommending an accessory device, according to one or more embodiments. A user device 802 (e.g., user device 104) can be in communication with a discovery broker 804 (e.g., discovery broker 208). At 806, the user device 802 can request a list of accessory devices from streaming content 806. This can be analogous to 714 of FIG. 7. For example, the user device 802 can connect to a first network (e.g., first network 216) similarly to 712 of FIG. 7 and request the list of accessory devices for streaming content.

At 808, the discovery broker 804 can transmit an accessory group list to the user device 802. The list can be transmitted in response to the request at 806. The accessory device list can include accessory devices (e.g., first accessory device 108, second accessory device 110) that are available for use. For example, an accessory device can include a smart speaker, a media streaming device (e.g., Apple TV) that is available to a user associated with the user device 802.

At 810, the user device 802 can determine a connection with an accessory device (e.g., first accessory device 108). For example, the user device 802 can transmit an association request to the accessory device, and the accessory device can respond. In another example, the user device may ping the accessory device and wait for a response to determine whether it can send to and receive data packets from the accessory device. The user device 802 may use other techniques to determine whether it is connected with the accessory device.

At 812, the user device 802 can detect a first location signature. In some instances, the location signature can be detected while the user device 802 is connected to the accessory device. Detecting the location signature can be performed using various techniques. For example, the user device can determine the characteristics of a nearby AP (e.g., room access point 112). The AP characteristics can include, for example, a received signal strength indication (RSSI) of a signal from the AP. The AP characteristics can also include an AP fingerprint, such as a service set identifier (SSID) associated with the AP or a medium access control (MAC) address associated with the AP. The user device 802 can further store the location signature in memory. For example, if the user is a hotel guest, the user device 802 can store the location signature of the guest's room in memory. The user device 802 can further store an accessory device identifier (e.g., device identifier value or other identifier) in memory and further associate the accessory device identifier with the first location signature.

At 814, the user device 802 can detect a second location signature 814. For example, the user can take their user device 802 and move to another location, such as from a hotel room to a lobby, restaurant, or pool. The new location can have a different location signature. For example, one of the RSSI of an AP at the new location, an SSID associated with the AP at the new location, or a MAC address associated the AP at the new location, or some other location signature characteristic can be different than the first location signature. The user device 802 can further compare the second location signature with the first location signature. Based on a difference between location signatures, the user device 802 can store the second location signature in memory.

At 816, the user device can detect the first location signature 816. For example, the user may have returned to their hotel room. Upon returning to the hotel room, the user device 802 can connect with the AP in the room. The user device 802 can detect the first location signature and compare it to each stored location signature. Based on the comparison, the user device 802 can determine that the first location signature at 816 is the same first location signature at 812.

At 818, the user device can display a recommendation to use the accessory device. For example, the user device 802 can determine whether any accessory devices are associated with the first location signature. The user device 802 can further determine that the accessory device identified at 810 is associated with the first location signature. The user device 802 can display a prompt on the user device's display suggesting that the user use the accessory device. The user can choose to accept the suggestion or ignore the suggestion. The user device 802 can receive an input indicating that the user accepts the suggestion and reestablish a connection with the accessory device. The user device 802 can then stream content via the accessory device. It should be appreciated that in some instances, the user device 802 can provide a prompt with a suggestion to engage with an accessory device after the user device 802 has initially scanned the QR code.

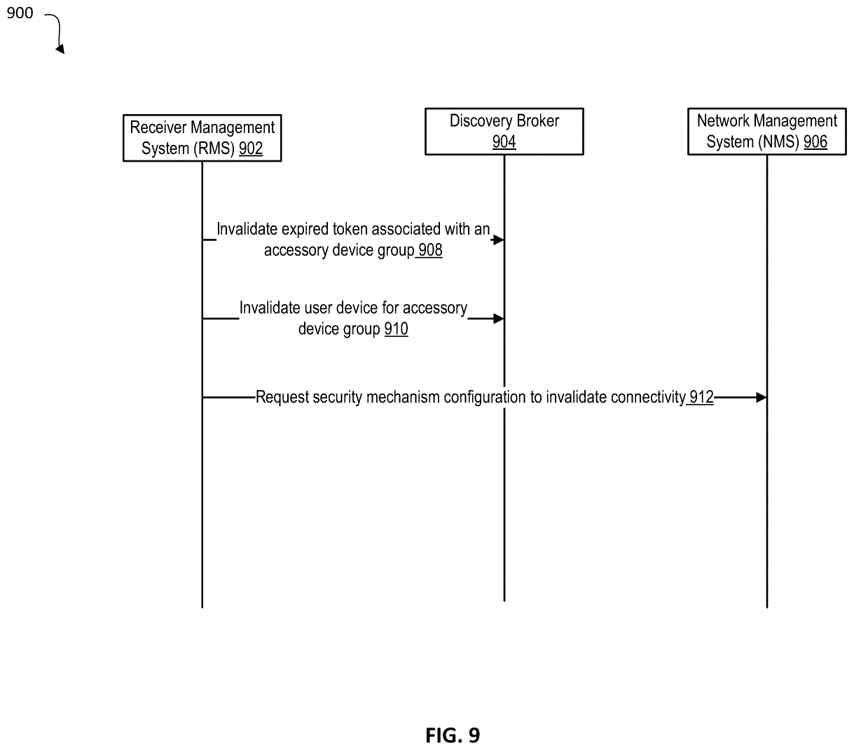

FIG. 9 is a signaling diagram 900 for an example process for invalidating connectivity, according to one or more embodiments. As illustrated, an RMS 902 can be in communication with a discovery broker 904 and an NMS 906. The RMS 902 can access booking information related to any defined space (e.g., room) on a premises. Therefore, the RMS 902 can identify the expiration of each booking, which should correspond to loss of use of the accessory device group in the defined space. At 908, the RMS 902 can transmit a message, to the discovery broker 904, to invalidate the any token associated with the accessory device group. In response, the discovery broker 904 can invalidate any token associated with the accessory device group.

At 910, the RMS 902 can transmit a message to the discovery broker 904 to invalidate an authorization of any user device associated with the token to use the accessory device group. In response, the discovery broker 904 can invalidate the authorization of any user device associated with the expired token to use the accessory device group.

At 912, the RMS 902 can transmit a message to the NMS 906 to reconfigure the security mechanism to prohibit a connection between the user device and the accessory device group. In response, the NMS 906 can reconfigure the security mechanism to prohibit a connection between the user device and the accessory device group. For example, the NMS 906 can reconfigure a firewall to prevent the user device from connecting to the network.

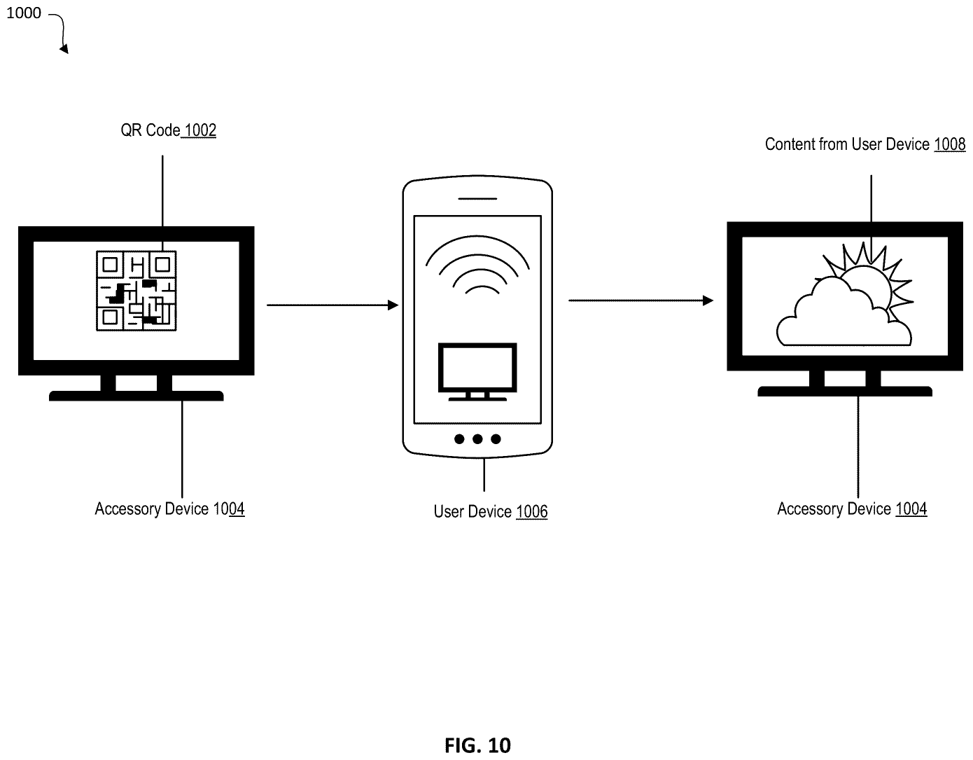

FIG. 10 is an illustration of onboarding with a booking-specific captive portal token, according to one or more embodiments. In some instances, a premises, such as a hotel generates a captive portal, which can be a webpage that a user may be required to interact with prior to accessing a network. Captive portal pages can be used by airports and hotels to cause users to accept terms and conditions prior to granting access to the network. A user can be asked to enter personally identifiable information (e.g., a name or email address), be presented terms and conditions and asked to manually input an acceptance of the terms and conditions. For example, a user device can attempt to connect to a network, such as a hotel network. The hotel network can cause a web page to be presented on the user device. The web page can include a web-based interface for entering an input In some instances, the web page can ask for a username and room number. If a valid username (e.g., hotel guest) and corresponding room number, are entered into the web page, the user device may be permitted to connect to the network.

As described herein rather than enter personally identifiable information, a discovery broker can generate a booking-specific captive portal token. The discovery broker can further include the booking-specific captive portal token in the QR code 1002 displayed on an accessory device 1004. The booking-specific captive portal token can include a particular guest's booking information, such as dates of stay. The booking-specific captive portal token would not include any personally identifiable information for the guest. A user device 1006 can scan the QR code 1002, which can include information such as a network identifier, a network password, and an accessory device identifier, in addition to the booking-specific captive portal token. The user device 1006 can use the network identifier, a network password, and the booking-specific captive portal token to connect to the network.

The user device 1006 can connect with the accessory device 1004 as described herein (see, FIG. 6). The user device 1006 can further stream content 1008 to the accessory device 1004 as described herein. Furthermore, the booking-specific captive portal token can be shared by the user device 1006 with other devices to which the user may have access. For example, the user device 1006 is a smartphone and the user has also brought a tablet. In this instance, the smartphone can share the booking-specific captive portal token with the tablet and the tablet can connect to the network without the user having to input personally identifiable information into the tablet.

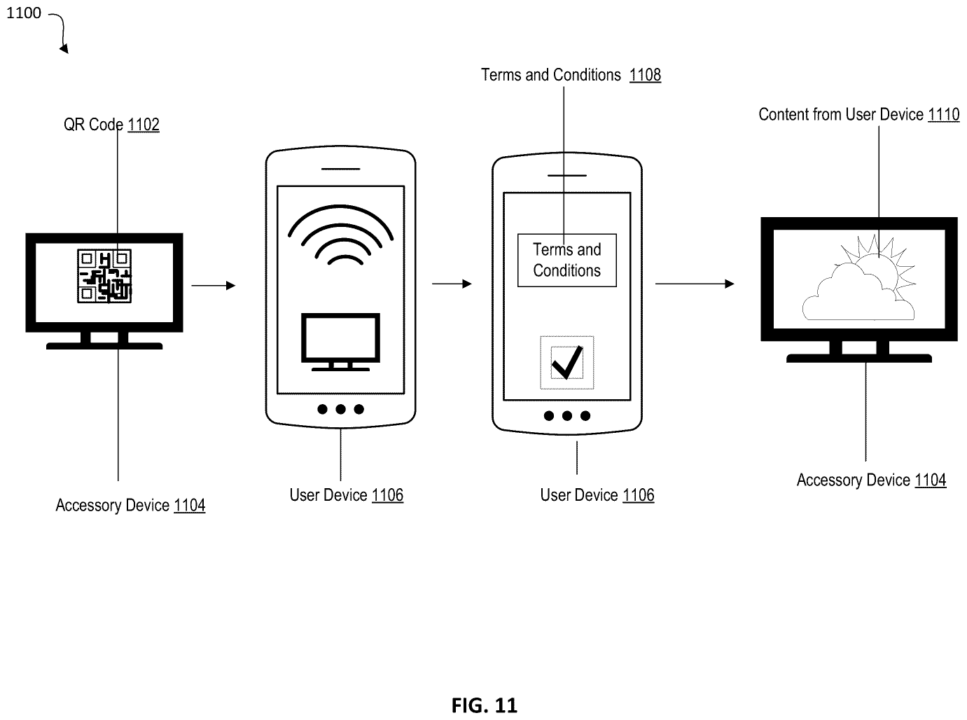

FIG. 11 is an illustration 1100 of onboarding with a booking-specific captive portal token, according to one or more embodiments. In some instances, a premises can require acceptance of the terms and conditions for connecting to a network and accessing the internet. In these instances, a discovery broker can generate a booking-specific captive portal token. The discovery broker can further include the booking-specific captive portal token in a QR code 1102 displayed on an accessory device 1104. A user device 1106 can scan the QR code 1102, which can include information such as a network identifier, a network password, and an accessory device identifier, in addition to the booking-specific captive portal token.

The user device 1106 can use the network identifier, a network password, and the booking-specific captive portal token to connect to the network. The terms and conditions 1108 can be displayed on the user device 1106 and the user can input an acceptance of the terms and conditions. It should be appreciated that the terms and conditions 1008 are displayed based on the booking-specific captive portal token and the user does not have to enter personally identifiable information to have the user device 1106 display the terms and conditions 1108.

The user device 1106 can then connect with the accessory device 1104 as described herein. The user device 1106 can further stream content 1110 to the accessory device 1104 as described herein.

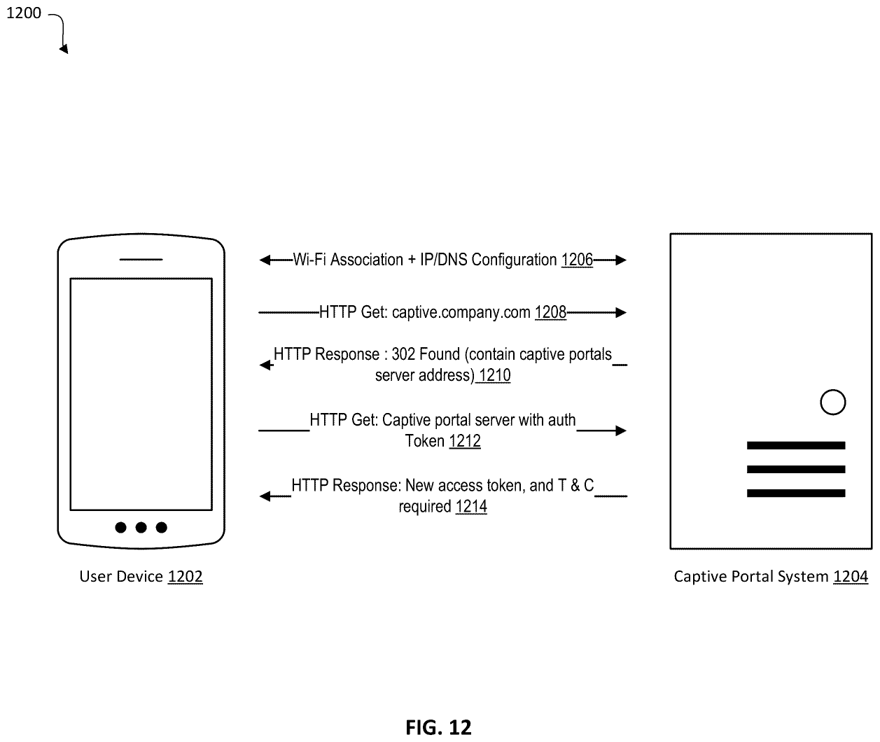

FIG. 12 is a signaling diagram for onboarding with a booking-specific captive portal token according to one or more embodiments. As illustrated, a user device 1202 (e.g., user device 104) is in communication with a captive portal system 1204. In some instances, the captive portal system 1204 can include a discovery broker. At 1206, the user device 1202 can scan a QR code displayed on an accessory device (e.g., accessory device 108). The QR code can provide a network configuration (e.g., Wi-Fi configuration) and a booking-specific captive portal token. The user device 1202 can join a network (e.g., a hotel Wi-Fi network) based on the information provided in the QR code and further complete an internet protocol (IP) configuration and a domain name server (DNS) configuration.

At 1208, the user device 1202 can begin a captive detection of the network. The user device can transmit a hypertext transmission protocol (HTTP) GET message to the captive portal system 1204 to access the internet.

At 1210, captive portal system 1204 can transmit an HTTP response message to the user device 1202. The HTTP response message can indicate that the network is captive and that the user device 1202 is not authorized to access the internet. For example, the HTTP response message can include various response codes and header information that indicate that the network is captive and that the user device 1202 is not authorized to access the internet.

At 1212, the user device 1202 can send an HTTP GET message to the captive portal system 1204. The HTTP GET message can indicate the availability of the booking-specific captive portal token. The HTTP GET message can further indicate an intention to engage in an authentication process using the booking-specific captive portal token. The HTTP GET message can further indicate that the authentication process is to be engaged by user devices that have previously obtained a booking-specific captive portal token.

At 1214, the captive portal system 1204 can respond to the HTTP GET message of 1212. For example, the captive portal system 1204 can then transmit an HTTP response message that indicates an authentication challenge. The HTTP response message can further provide information on how to properly engage in an authentication process using the booking-specific captive portal token. In response, the user device 1202 can transmit an HTTP GET message that includes the booking-specific captive portal token. The booking-specific captive portal token can be included in an “authorization” request header field. In some instances, the user device 120 can use a “bearer” authentication scheme to transmit the booking-specific captive portal token. In this scheme, the booking-specific captive portal token can be considered a “bearer” token. The booking-specific captive portal token is included in the “authorization request header field of the HTTP GET message. The captive portal system 1204 can authenticate the booking-specific captive portal token based on the booking-specific captive portal token being the correct token and being included in the appropriate part (e.g., “authorization” request header field) of the HTTP GET message.

The captive portal system 1204 can validate the booking-specific captive portal token. For example, the captive portal system 1204 can determine whether the booking-specific captive portal token provided by the user device 1202 is the same booking-specific captive portal token generated by the captive portal system 1204. The captive portal system 1204 can further record a session-stable identifier (e.g., an IP address) that can be used later in a pairing process between the user device 1202 and an accessory device.

The captive portal system 1204 can transmit an HTTP response message to the user device 1202. The HTTP response message can include a new booking-specific captive portal token. In some instances, the user device 1202 may still need to indicate an acceptance of terms and conditions for accessing the internet via the network. For example, if the user device 1202 had not previously indicated acceptance of the terms and conditions. In these instances, the user device can restart the captive portal process and cause the terms and conditions to be displayed on the user device 1202. If the user device 1202 indicates acceptance, then the captive portal system 1204 can grant access to the internet via the network. If the user device 1202 does not receive an indication of acceptance of the terms and conditions, then the captive portal system 1204 does not grant the access.

In some instances, the user device 1202 may need to rejoin the network after disconnecting from the network. The user device 1202 may further need to reengage in an authentication process. The process is similar to the process described above. In these instances, the user device 1202 can rejoin the network and complete the IP configuration and DNS configuration. The user device 1202 can transmit an HTTP GET message to the captive portal system 1204 to access the internet via the network. The captive portal system 1204 can respond with an HTTP response message indicating that the network is captive and that the user device 1202 is not authorized to access the internet.

The user device 1202 can transmit an HTTP GET message indicating an intent to use the booking-specific portal token to engage in an authentication process. The HTTP GET message can further indicate that the user device 1202 will only engage in the authentication process if it has previously obtained a booking-specific portal token.

The captive portal system 1204 can then transmit an HTTP response message that indicates an authentication challenge. The HTTP response message can further provide information on how to properly engage in an authentication process using the booking-specific captive portal token. In response, the user device 1202 can transmit an HTTP GET message that includes the booking-specific captive portal token. The booking-specific captive portal token included in an “authorization” request header field.

The captive portal system 1204 can validate the booking-specific captive portal token. For example, the captive portal system 1204 can determine whether the booking-specific captive portal token provided by the user device 1202 is the same booking-specific captive portal token generated by the captive portal system 1204. The captive portal system can further record a session-stable identifier (e.g., an IP address) that can be used later in a pairing process between the user device 1202 and an accessory device.

The captive portal system 1204 can transmit an HTTP response message to the user device 1202. The HTTP response message can a new booking-specific captive portal token. As the user device 1202 has already indicated an acceptance of terms and conditions, the HTTP response message can further indicate the acceptance. The captive portal system 1204 can grant the user device 1202 access to the internet via the network. The user device 1202 can access the internet.

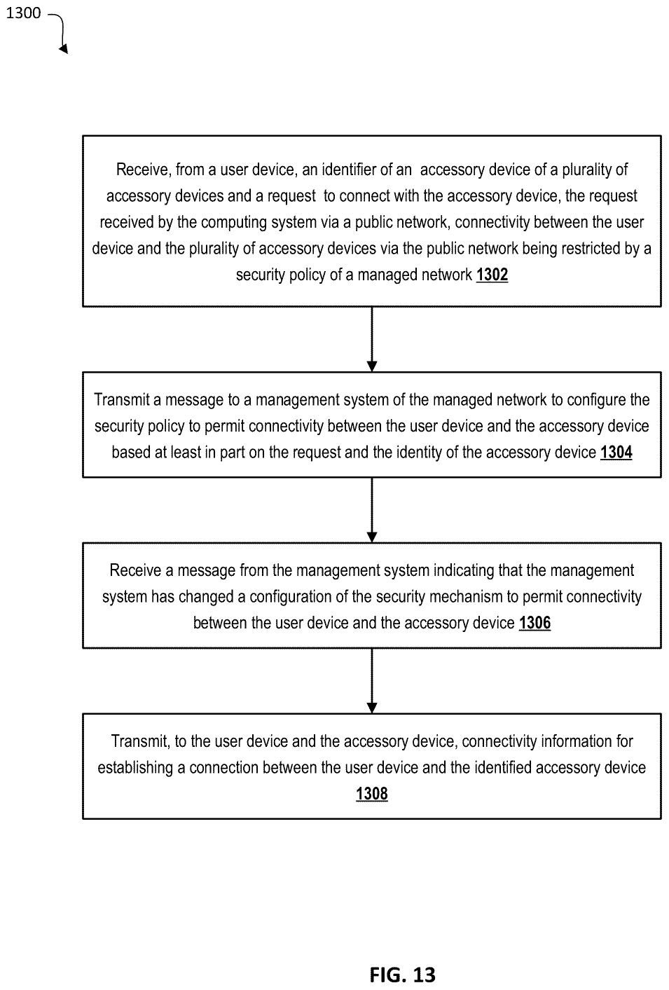

FIG. 13 is a process flow 1300 for device onboarding, according to one or more embodiments. At 1302, the method can include a computing system receiving, from a user device, an identifier of an accessory device of a plurality of accessory devices and a request to connect with the accessory device. The request can be received by the computing system via a first network. Furthermore, a security mechanism can be configured to restrict connectivity between the user device and the plurality of accessory devices. The computing system can be a discovery broker of the management system. The user device can be, for example, a smartphone of a user that has booked a stay on a commercial premises. The user may wish to use their user device to present content on an accessory device. In some instances, the computing system can validate the user device in response to receiving the request.

At 1304, the method can include the computing system transmitting a message to a management system of a managed network to configure the security mechanism to permit connectivity between the user device and the accessory device based at least in part on the request and the identity of the accessory device. The security mechanism can be a firewall that prevents communication between the user device and the accessory device.

At 1306, the method can include the computing system identifying the management system has changed a configuration of the security mechanism to permit connectivity between the user device and the accessory device.

At 1308, the method can include the computing system transmitting the user device and the accessory device, connectivity information for establishing a connection between the user device and the identified accessory device. The user device can then establish and connection with the accessory device. The user device can further transmit content to the accessory device for presentation.

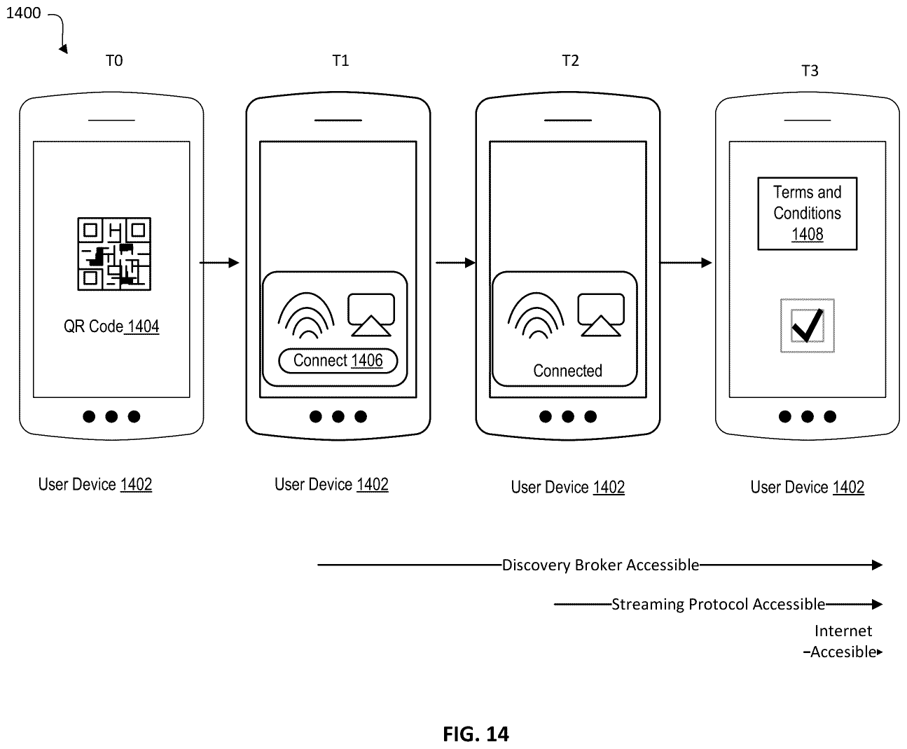

A user device can have different levels of accessibility during the processes described herein. FIG. 14 provides a high-level illustration of different levels of accessibility during different stages of the process. FIG. 14 is an illustration 1400 indicating accessibility for a user device, according to one or more embodiments. At T0, a user device 1402 (e.g., user device 104) can scan a QR code 1404 being displayed on an accessory device (e.g., first accessory device). The user device 1402 can further engage with a discovery broker (e.g., discovery broker 208) to access a network (e.g., a hotel network). A process for connecting with the discovery broker is described in more detail with respect to FIG. 2.

At T1, the user device 1402 can communicate with the discovery broker and the display prompt 1406 to connect to the network. At T1, the user device 1402 can access the discovery broker. A user can interact with the prompt 1406 or ignore the prompt 1406. For the purposes of FIG. 14, it can be assumed that the user interacts with the prompt 1406 to connect to the network.

At T2, the user device 1402 can be connected to the network, but not have access to the internet. The user device 1402 may further be connected to the accessory device. For example, the user device 102 can be connected to the accessory device that displayed the QR code 1404. At T2, the user device 1402 can use a streaming protocol (e.g., Apple AirPlay) to stream content on the accessory device. At T2, the user still may not have accepted the terms and conditions 1408 yet, and therefore, may not have access to the internet.

At T3, the user device 1402 can have accepted the terms and conditions 1408. For example, the user device 1402 can indicate an acceptance of the terms and conditions 1408 of the hotel. At T3, the user device 1402 can be granted access to the internet.

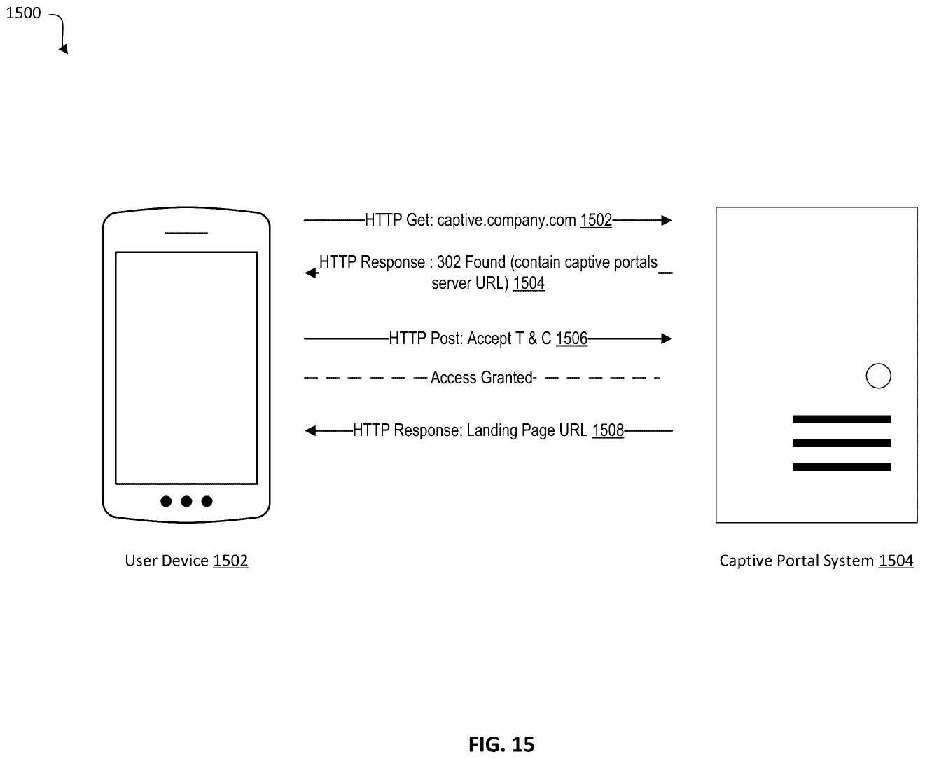

FIG. 15 is a signaling diagram 1500 for onboarding with a captive portal token according to one or more embodiments. At 1502, the user device 1502 can begin a captive detection of a network. The user device 1502 can transmit a hypertext transmission protocol (HTTP) GET message to the captive portal system 1504 to access the internet.

At 1506, captive portal system 1504 can transmit an HTTP response message to the user device 1502. The HTTP response message can indicate that the network is captive and that the user device 1202 is not authorized to access the internet. For example, the HTTP response message can include various response codes and header information that indicate that the network is captive and that the user device 1502 is not authorized to access the internet. In response, the user device 1502 and the captive portal system 1504 can engage in a steps similar to steps 1212 and 1214. The user device 1502 can further transmit an indication of an acceptance of the terms and conditions.

At 1508, the captive portal system 1504 can transmit an HTTP response message to the user device 1502. The HTTP response message can include a new booking-specific captive portal token. As the user device 1502 has indicated acceptance, the captive portal system 1504 can grant access to the internet via the network. The captive portal system 1504 can further cause a landing page to be displayed on the user device 1502.

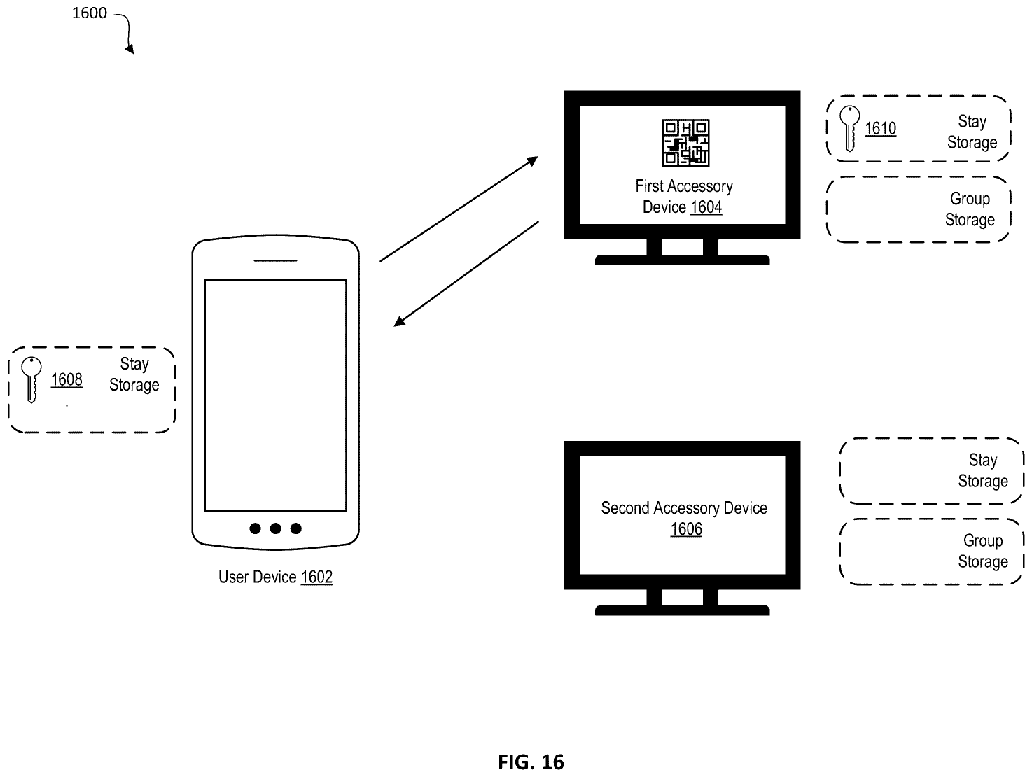

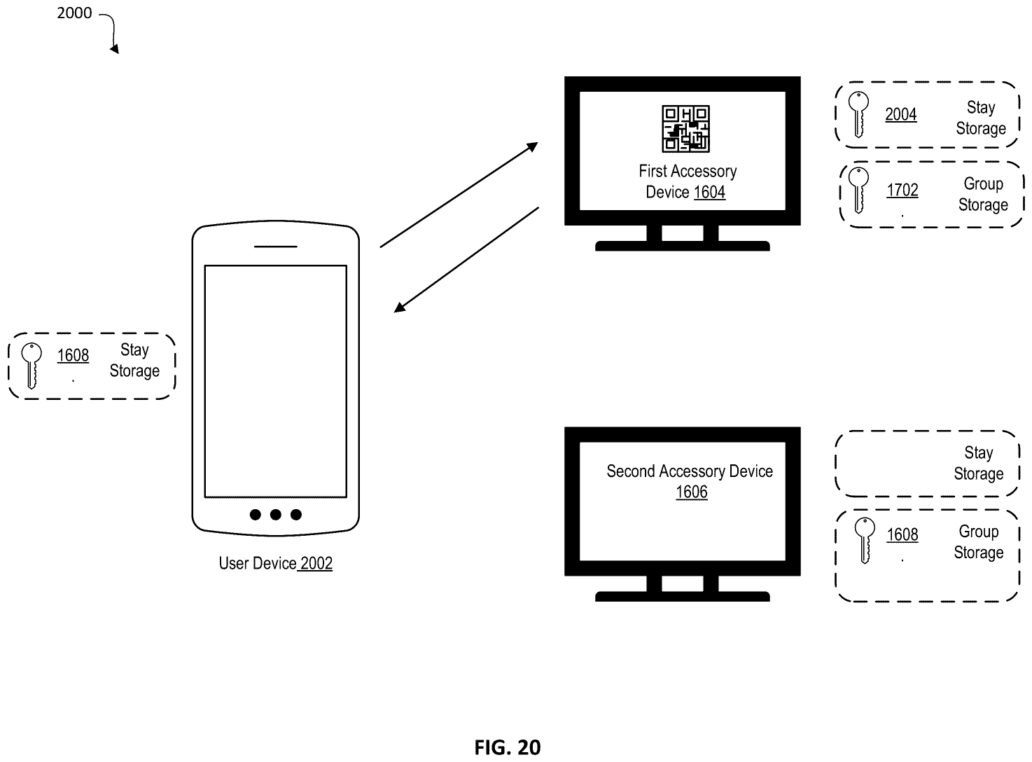

In some instances, accessory devices can be configured to communicate with each other and a user device. In particular, the user device and the accessory devices can be configured to exchange keys that enable a user device to pair with and communicate with an accessory device. FIGS. 16-22 help describe this key exchange process. The keys can be used between devices to authenticate each other device. The following figures assist in describing an exchange of key, such that a user does not have to enter a pin for a second accessory device after having exchanged keys with a first accessory device. A first process can include process for an initial exchange of keys between accessory devices. A second process can include connecting with an accessory device after the accessory devices have exchanged keys. FIGS. 16-19 can relate to the first process. FIGS. 20-22 can relate to the second process.

FIG. 16 is an illustration 1600 of a process for exchanging keys, according to one or more embodiments. A user device 1602 can have access to multiple accessory devices. For example, in a defined space such as a hotel room (e.g., room 106), the hotel may have provided a first accessory device 1604 and a second accessory device 1606. If accessible, the user device 1602 may be able to stream content via either accessory device. The user device 1602 can scan a QR code on a first accessory device 1604 and begin a process for exchanging keys. The user device can access a first accessory device key 1608 from the first accessory device 1604 and the first accessory device 1604 can access a user device key 1610 from the user device 1602. At this point the second accessory device 1606 has not accessed either the first accessory device key 1608 or the user device key 1610. Both the user device 1602 and the first accessory device 1604 can store their respective keys in a temporary storage (e.g., stay storage). This temporary storage can be deleted upon the user checking out of the hotel.

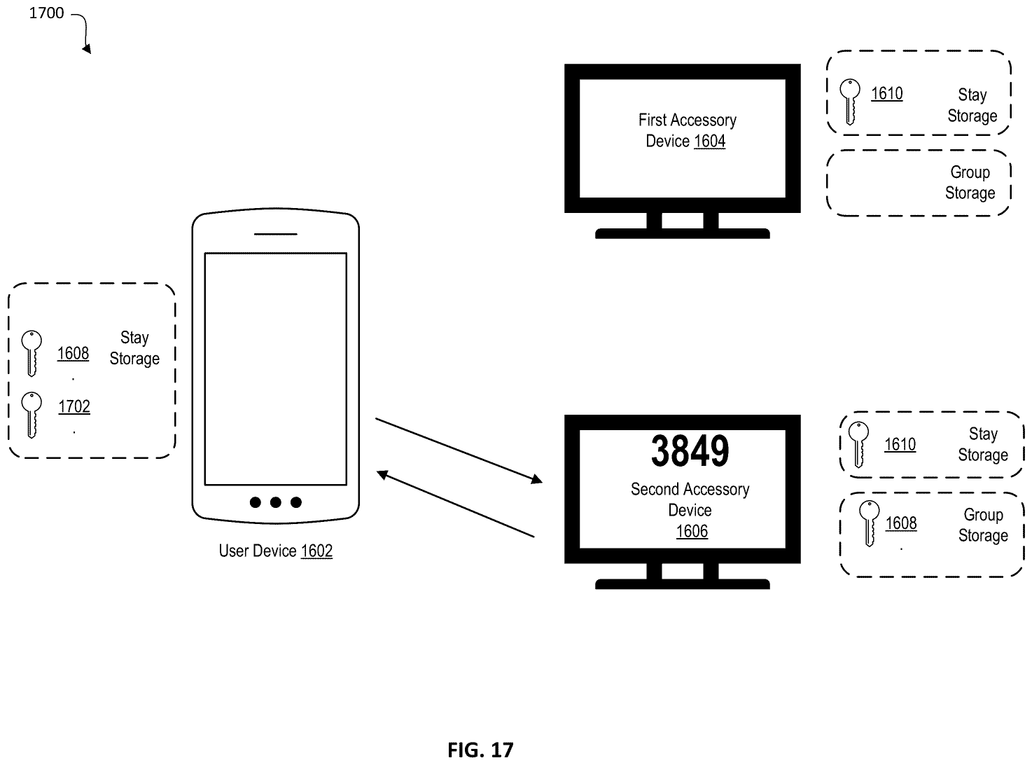

FIG. 17 is an illustration 1700 of a process for exchanging keys, according to one or more embodiments. The user device 1602 can use pin code (in other instances, the user device can scan a QR code) displayed on the second accessory device 1606 and begin a process for exchanging keys. The user device 1602 can access a second accessory device key 1702 from the second accessory device 1606 and the second accessory device 1606 can access a user device key 1610 from the user device 1602. The second accessory device 1606 can further access the first accessory device key 1608 from the user device 1602. At this point, the user device has stored the first accessory device key 1608 and the second accessory device key 1702. The first accessory device 1604 has stored the user device key 1610. The second accessory device 1606 has stored the user device key 1610 and the first accessory device key 1608. The second accessory device 1606 can store the first accessory device key 1608 in long term storage (e.g., group storage). Unlike the temporary storage which is deleted after the user check out of the hotel, the long term storage can persist past the user's stay at the hotel.

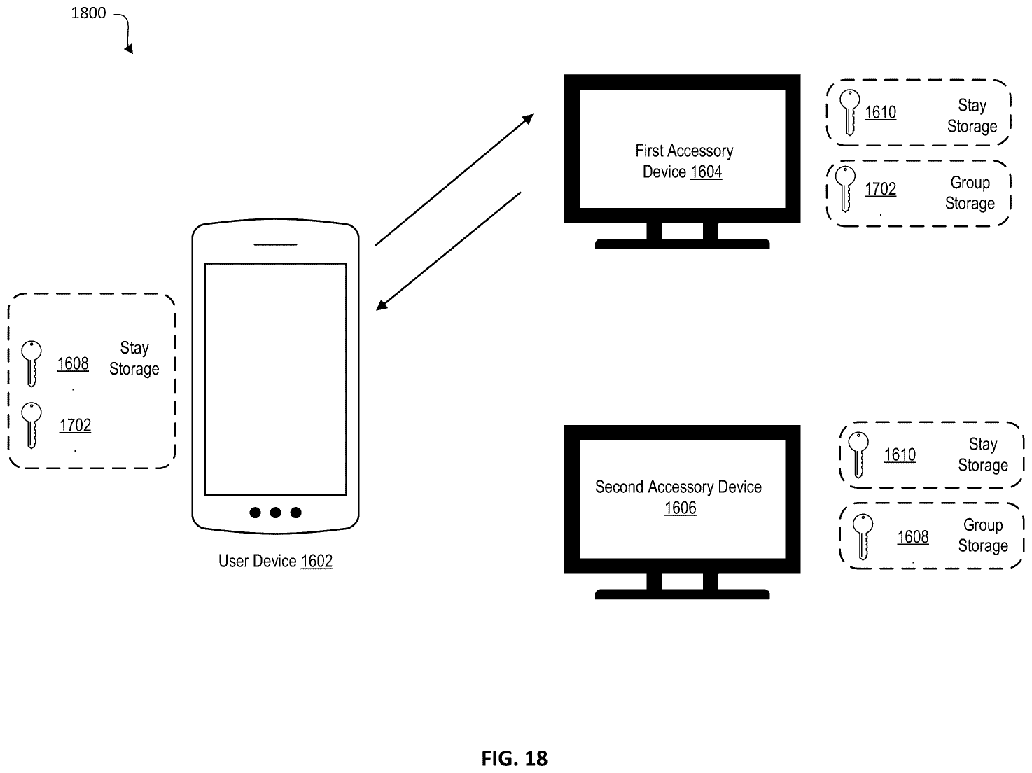

FIG. 18 is an illustration 1800 of a process for exchanging keys, according to one or more embodiments. After exchanging keys with the second accessory device 1606 the user device 1602 can communicate with the first accessory device 1604, which can access the second accessory device key 1702 from the user device 1602. At this point, each of the devices has each other's key. FIGS. 16-18 describe an initial key exchange. For example, when a hotel arranges the first accessory device 1604 and the second accessory device 1606 in the room, a guest can use their user device to cause a process such that each device has each other device's keys.

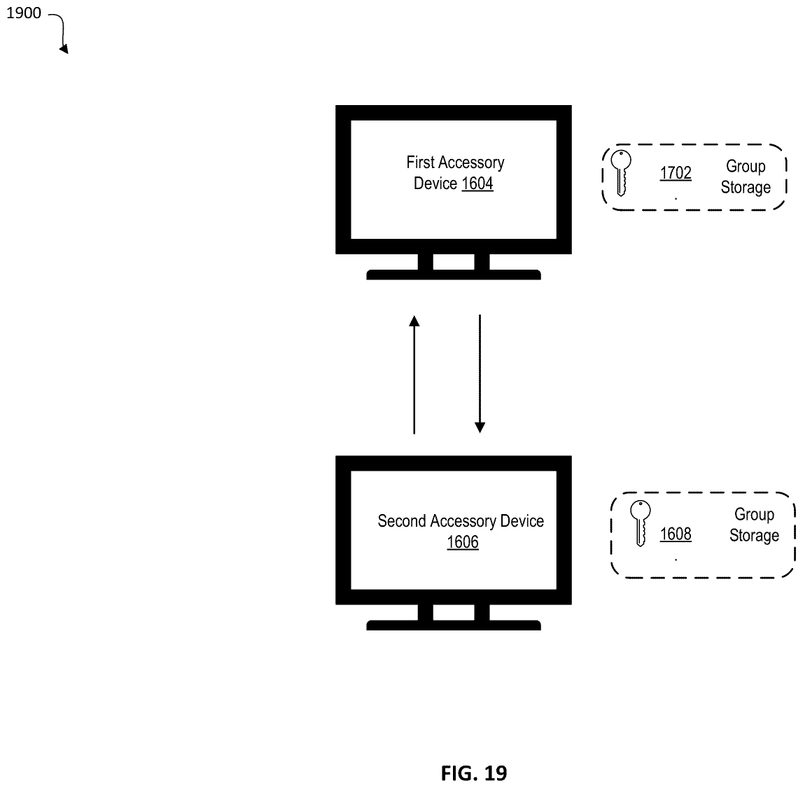

FIG. 19 is an illustration 1900 of a process for exchanging keys, according to one or more embodiments. As indicated with respect to FIG. 18, the first accessory device 1604 has the second accessory device key 1702 and the second accessory device 1606 has the first accessory device key 1608. Therefore, the first accessory device 1604 and the second accessory device 1606 can use their respective keys to pair with and communicate with each other.

FIGS. 20-22 relate to scenarios after the first process has already occurred and the accessory devices have each other's keys. FIG. 20 is an illustration 2000 of a process for exchanging keys, according to one or more embodiments. A user can enter the same room as in FIGS. 16-19. The user device 2002 can be used to scan a QR code on the first accessory device 1604. The user device 2002 can be different than the user device 1602 of FIGS. 16-19. For example, the user device 2002 may belong to a different guest than the user device 1602. The user device 2002 can access the first accessory device key 1608 from the first accessory device 1604. The first accessory device 1604 can access the user device key 1610 from the user device key 2004 from the user device 2002. As described with respect to FIGS. 16-19, the first accessory device 1604 may have already obtained the second accessory device key 1702 and the second accessory device 1606 may have already obtained the first accessory device key 1608.

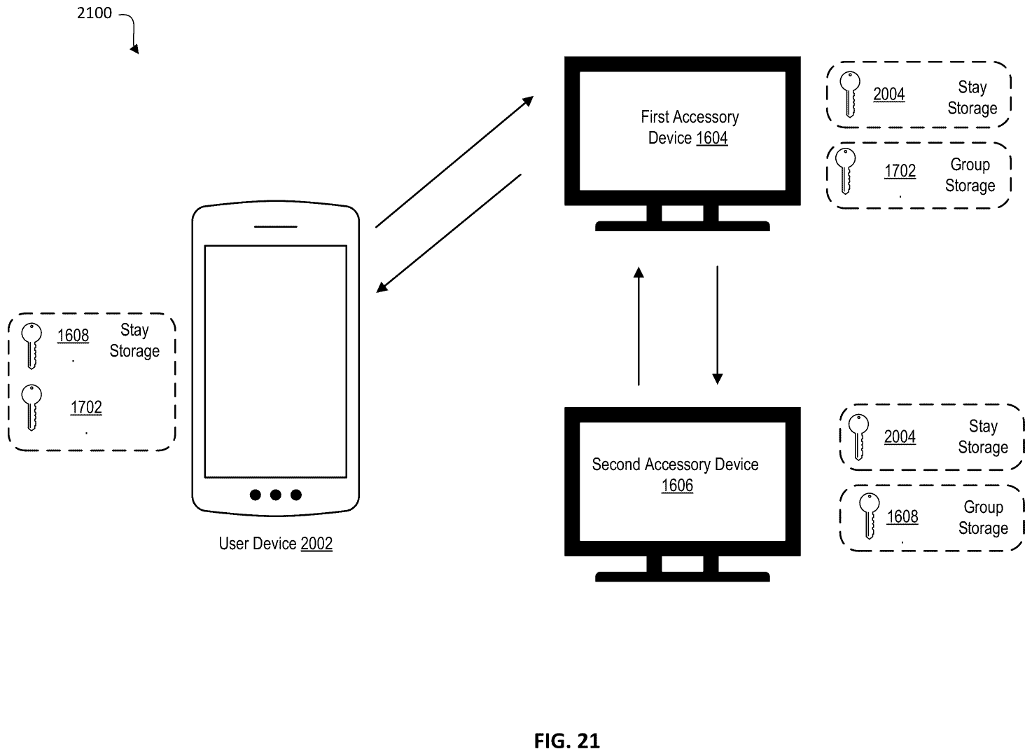

FIG. 21 is an illustration 2100 of a process for exchanging keys, according to one or more embodiments. The user device 2002 can communicate with the first accessory device 1604 and access the second accessory device key 1702. Furthermore, the first accessory device 1604 can communicate with the second accessory device 1606, and the second accessory device can access the user device key 2004 from the first accessory device 1604. As the first accessory device 1604 and the second accessory device 1606 already have each other's keys, no further exchange of keys is required between them.

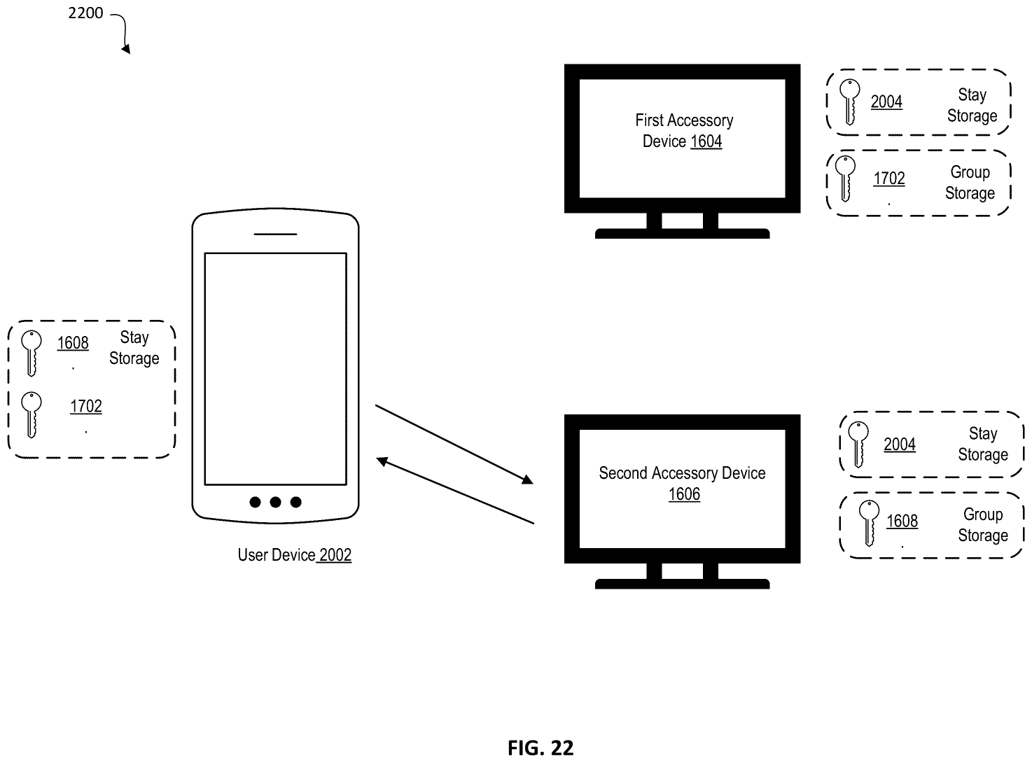

FIG. 22 is an illustration 2200 of a process for communicating between devices, according to one or more embodiments. As illustrated, the user device 2002 has the second accessory device key 1702 and the second accessory device 1606 already has the user device key 2004. Therefore, unlike as in FIG. 17, in which the user device 1602 needs a pin code from the second accessory device 1606 to exchange keys, the user device 2002 can connect with the second accessory device 1606 without the necessity of a pin code. The user can then enjoy the use of both the first accessory device 1604 and the second accessory device 1606.

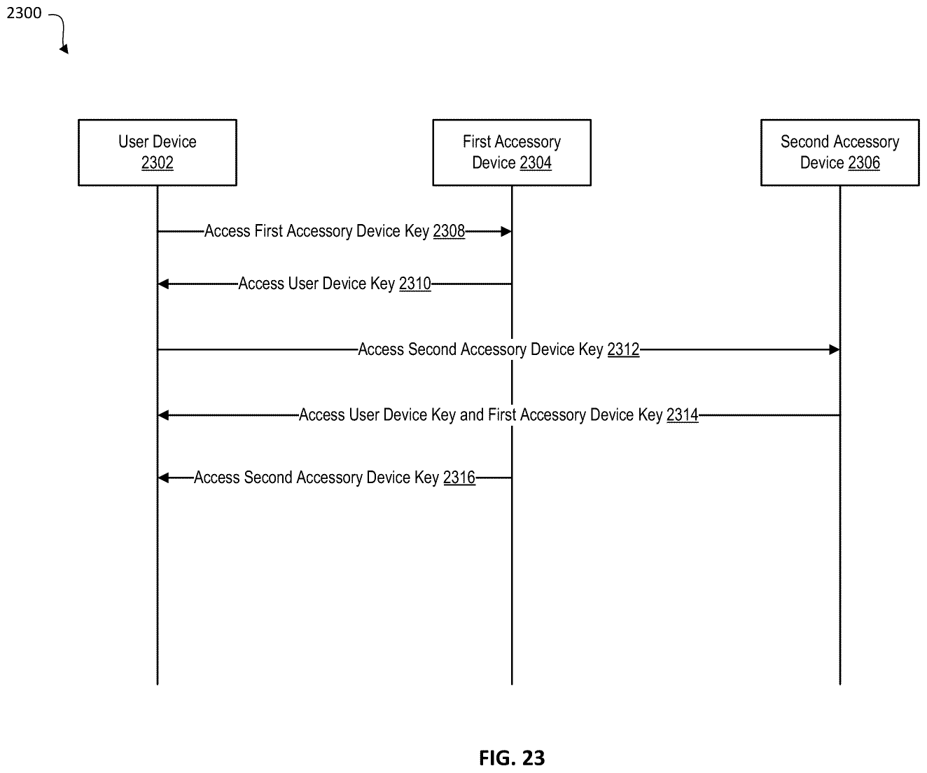

FIG. 23 is a signaling diagram 2300 for an initial exchange of keys, according to one or more embodiments. FIG. 23 relates to FIGS. 16-19. As illustrated, a user device 2302 (e.g., user device 1602) is in communication with a first accessory device 2304 (e.g., first accessory device 1604) and a second accessory device 2306 (e.g., second accessory device 1606). At 2308, the user device 2302 can access a first accessory device key 2308 from the first accessory device 2304. For example, a user in a defined space (e.g., a room) can use their user device 2302 to communicate with the first accessory device 2304 and request the first accessory device key. At 2310, the first accessory device 2304 can access a user device key from the user device 2302. The user device 2302 and the first accessory device 2304 can establish a communication session in which there is a mutual exchange of keys. The keys can be part of pairing information to be used to pair the first accessory device 2304 with the user device 2302. The communication session can be established by the user device 2302 scanning a QR code displayed on the first accessory device 2304. As described above, the user device 2302 can use the information from the QR code to communicate with a discovery broker to access a network and communicate with the first accessory device 2304.

At 2312, the user device 2302 can access a second accessory device key from the second accessory device 2306. At 2314, the second accessory device 2306 can access the user device key from the user device 2302. The second accessory device 2306 can further access the first accessory device key from the user device 2302. The user device 2302 and the second accessory device 2306 can establish a communication session in which there is a mutual exchange of keys. As indicated in FIG. 17, the second accessory device may display a pin code. The pin code may need to be entered into the user device 2302 in order to establish the communication session. The keys can be part of pairing information to be used to pair the second accessory device 2306 with the user device 2302. At 2316, the first accessory device 2304 can access the second accessory device key from the user device 2302. As the first accessory device 2304 and the second accessory device 2306 have each other's respective keys, the two devices can communicate with each other.

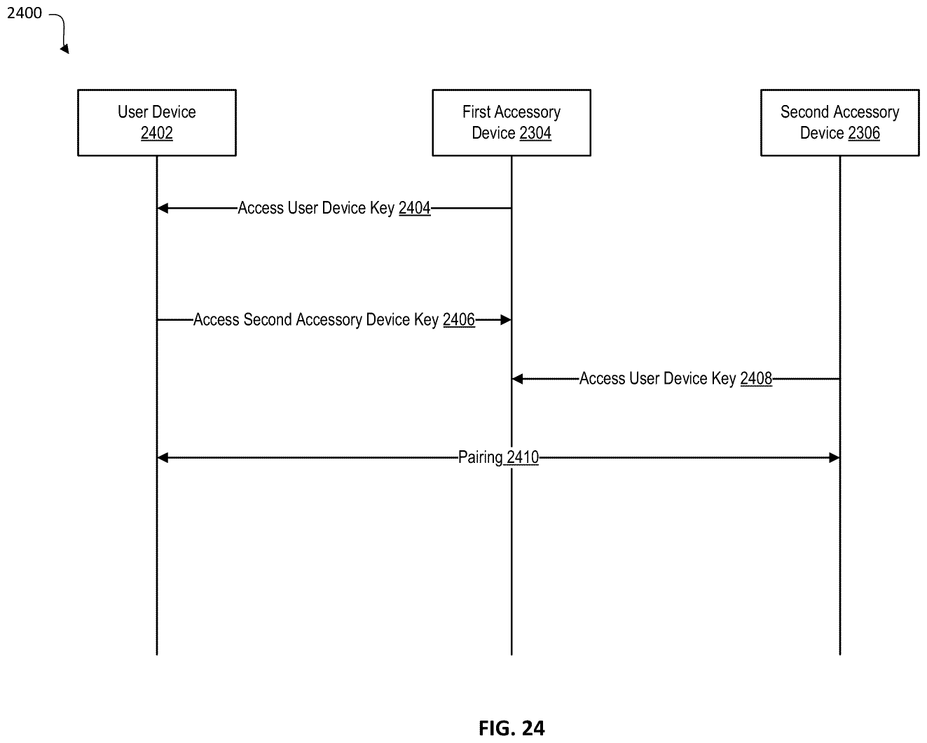

FIG. 24 is a signaling diagram 2400 for connecting with an accessory device, according to one or more embodiments. FIG. 24 relates to FIGS. 20-22. As illustrated a user device 2402 (e.g., user device 2002) is in communication with a first accessory device 2304 and a second accessory device 2306. At 2404, the first accessory device can access a user device key from the user device 2402. At 2406, the user device 2402 can access a second accessory device key from the first accessory device 2304. A communication session can be established by the user device 2402 scanning a QR code displayed on the first accessory device 2304. As described above, the user device 2402 can use the information from the QR code to communicate with a discovery broker to access a network and communicate with the first accessory device 2404. The first accessory device 2304 can have the second accessory device key stored in memory based on step 2316 of FIG. 23.

At 2408, the second accessory device 2306 can access the user device key from the first accessory device 2304. The first accessory device 2304 and the second accessory device can have the information to communicate with each other based on steps 2314 and 2316 of FIG. 23. At 2410, the user device can use the second accessory device key to pair with the second accessory device 2306. Unlike step 2316 of FIG. 23, the user device 2402 did not have to use a pin code to establish a connection with the second accessory device 2306. Furthermore, a future user device will also not have to use the pin code, as both the first accessory device 2304 and the second accessory device 2306 have each other's respective keys.

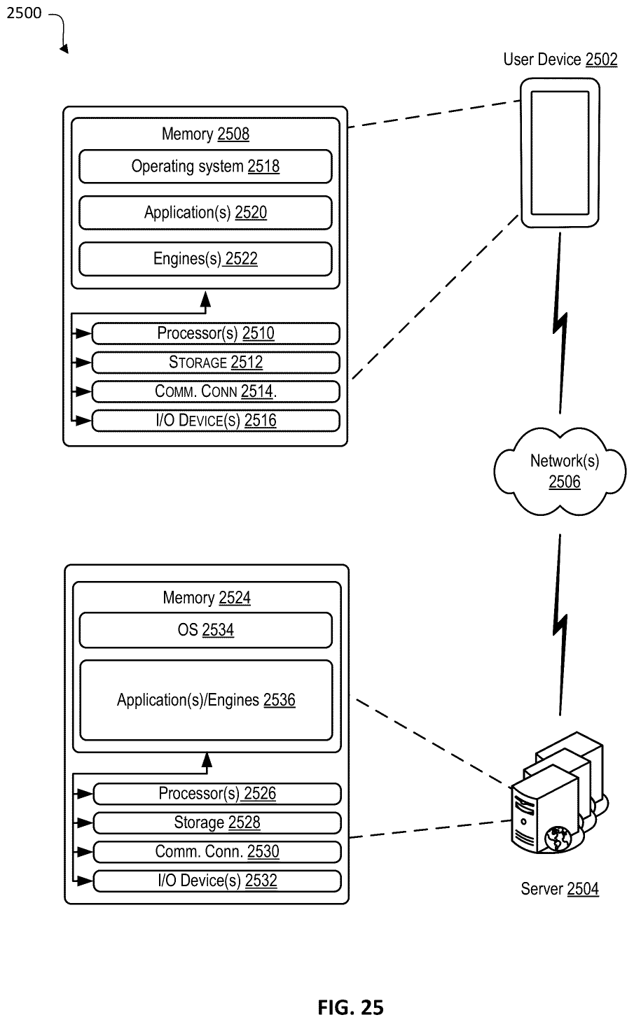

FIG. 25 illustrates an example architecture or environment 2500 configured to implement techniques described herein, according to one or more embodiments. The architecture 2500 includes a user device 2502 and a server 2504 (e.g., the hotel server). In some examples, the example architecture 2500 may further be configured to enable the user device 2502 and the server 2502 to share information. In some examples, the devices may be connected via one or more networks 2506 (e.g., via a first network). In some examples, the server 2504 may be configured to implement at least some of the techniques described herein with reference to the user device 2502 and vice versa.

In some examples, the networks 2506 may include any one or a combination of many different types of networks, such as cable networks, the Internet, wireless networks, cellular networks, satellite networks, other private and/or public networks, or any combination thereof. While the illustrated example represents the user device 2502 accessing the server 2504 via the networks 2506, the described techniques may equally apply in instances where the user device 2502 interacts with the server 2504 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 2502 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 2502 may be in communication with the server 2504 via the network 2508, or via other network connections.

In one illustrative configuration, the user device 2502 may include at least one memory 2508 and one or more processing units (or processor(s)) 2516. The processor(s) 2510 may be implemented as appropriate in hardware, computer-executable instructions, firmware, or combinations thereof. Computer-executable instructions or firmware implementations of the processor(s) 2510 may include computer-executable or machine-executable instructions written in any suitable programming language to perform the various functions described. The user device 2502 may also include geo-location devices (e.g., a global positioning system (GPS) device or the like) for providing and/or recording geographic location information associated with the user device 2502. In some examples, the processors 2510 may include a GPU and a CPU.

The memory 2508 may store program instructions that are loadable and executable on the processor(s) 2510, as well as data generated during the execution of these programs. Depending on the configuration and type of the user device 2506, the memory 2508 may be volatile (such as random access memory (RAM)) and/or non-volatile (such as read-only memory (ROM), flash memory). The user device 2502 may also include additional removable storage and/or non-removable storage 2512 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 2508 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 2508 and the additional storage 2512, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 2508 and the additional storage 2512 are both examples of non-transitory computer-storage media. Additional types of computer-storage media that may be present in the user device 2502 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 2502. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 2502 may also contain communications connection(s) 2514 that allow the user device 2502 to communicate with a data store, another computing device or server, user terminals, and/or other devices via the network 2506. The user device 2502 may also include I/O device(s) 2516, such as a keyboard, a mouse, a pen, a voice input device, a touch screen input device, a display, speakers, and a printer.

Turning to the contents of the memory 2508 in more detail, the memory 1208 may include an operating system 2518 and/or one or more application programs or services for implementing the features disclosed herein such as applications 2520. At least some techniques described with reference to the server 2504 may be performed by the user device 2502 and vice versa.

The server 2504 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the server 2504 may be in communication with the user device 2502 via the network 2508, or via other network connections.

In one illustrative configuration, the server 2504 may include at least one memory 2524 and one or more processing units (or processor(s)) 2526. The processor(s) 2526 may be implemented as appropriate in hardware, computer-executable instructions, firmware, or combinations thereof. Computer-executable instructions or firmware implementations of the processor(s) 2526 may include computer-executable or machine-executable instructions written in any suitable programming language to perform the various functions described.

The memory 2524 may store program instructions that are loadable and executable on the processor(s) 2526, as well as data generated during the execution of these programs. Depending on the configuration and type of service provider computer 2502, the memory 2524 may be volatile (such as RAM) and/or non-volatile (such as ROM and flash memory). The server 2504 may also include additional removable storage and/or non-removable storage 2528 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 2524 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 2542 and the additional storage 2528, both removable and non-removable, are both additional examples of non-transitory computer-readable storage media.

The server 2504 may also contain communications connection(s) 2530 that allow the server 2504 to communicate with a data store, another computing device or server, user terminals, and/or other devices via the network 2508. The server 2504 may also include I/O device(s) 2532, such as a keyboard, a mouse, a pen, a voice input device, a touch input device, a display, speakers, and a printer.

Turning to the contents of the memory 2524 in more detail, the memory 2524 may include an operating system 2534 and/or one or more application programs 2536 (e.g., discovery broker) or services for implementing the features disclosed herein.

While specific embodiments have been described, one skilled in the art will recognize that numerous modifications are possible. A single controller may use processes described herein to establish pairings with any number of accessories and to selectively communicate with different accessories at different times. Similarly, a single accessory may be controlled by multiple controllers with which it has established pairings. Any function of an accessory may be controlled by modeling the function as a service having one or more characteristics and allowing a controller to interact with (e.g., read, modify, receive updates) the service and/or its characteristics. Accordingly, protocols and communication processes as described herein may be “universal,” meaning that they may be applied in any context with one or more controllers and one or more accessories regardless of accessory function or controller form factor or specific interfaces.

Thus, although specific embodiments have been described, it will be appreciated that embodiments may include all modifications and equivalents within the scope of the following claims.

As described above, one aspect of the present technology is the gathering and use of data available from specific and legitimate sources to improve the delivery of messages from one device to one or more devices. The present disclosure contemplates that in some instances, this gathered data may include personal information data that uniquely identifies or may be used to identify a specific person. Such personal information data may include demographic data, location-based data, online identifiers, telephone numbers, email addresses, home addresses, (e.g., retrieving location information from a user specific fitness-based application or a user specific healthcare application for route reconstruction).

The present disclosure recognizes that the use of such personal information data, in the present technology, may be used to the benefit of users. For example, the personal information data may be used to deliver a command from a user profile on a computing device to one or more computing devices. Further, other uses for personal information data that benefit the user are also contemplated by the present disclosure. For instance, recommendations for improving the user's driving efficiency may be transmitted from a device back to the user profile.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities may subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements may be provided to prevent or block access to such personal information data. For example, such as in the case of token generation services, the present technology may be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Illustrative techniques for using a computing devices to delegate authority to generate a token from an owner to a sharing platform, and provisioning the token by the sharing platform. Some or all of these techniques may, but need not, be implemented at least partially by as those shown at least in FIGS. 1-9 above. While many of the embodiments are described above with reference to computing devices and user devices, it should be understood that other types of computing devices may be suitable to perform the techniques disclosed herein. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various embodiments further can be implemented in a wide variety of operating environments, which in some cases can include one or more user computers, computing devices or processing devices that can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium that can be used to store the desired information and that can be accessed by the a system device. Based at least in part on the disclosure and teachings provided herein, a person of ordinary skill in the art will appreciate other ways and/or methods to implement the various embodiments. However, computer-readable storage media does not include transitory media such as carrier waves or the like.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a,” “an,” and “the,” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based at least in part on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A method, comprising:
receiving, by a computing system and from a user device, an identifier of an accessory device of a plurality of accessory devices and a request to connect with the accessory device, the request received by the computing system via a first network, connectivity between the user device and the plurality of accessory devices via the first network being restricted by a security mechanism of a second network;
transmitting, by the computing system, a message to a management system of the second network to configure the security mechanism to permit connectivity between the user device and the accessory device based at least in part on the request and the identity of the accessory device;
receiving, by the computing system, a message from the management system indicating that the management system has changed a configuration of the security mechanism to permit connectivity between the user device and the accessory device; and
transmitting, by the computing system and to the user device and the accessory device, connectivity information for establishing a connection between the user device and the identified accessory device.

2. The method of claim 1, wherein the method further includes validating the user device in response to receiving the request, wherein transmitting the message to the management system is based at least in part on the validation.

3. The method of claim 1, wherein the request comprises private key information for establishing a secure connection between the user device and the computing system.

4. The method of claim 3, wherein the private key information comprises a transport layer security (TLS) key and a transport layer security (TLS) key identity.

5. The method of claim 1, wherein the computing system is connected to the user device via a first network separate from the second network.

6. The method of claim 1, wherein the security mechanism comprises a firewall configured to restrict connectivity via the first network between the user device and the identified accessory device.

7. The method of claim 1, wherein the identified accessory device is a first accessory device arranged in a defined space, wherein a second accessory device of the plurality of accessory devices is arranged in the defined space, and wherein the management system changes management system has further changed the configuration of the security mechanism to permit connectivity between the user device and the second accessory device.

8. The method of claim 7, wherein the defined space is a room or a set of rooms in a building.

9. The method of claim 7, wherein an access point is arranged in the defined space, and wherein the user device communicates with the computing system via the access point.

10. A computing system, comprising:
one or more processors; and
one or more non-transitory computer-readable media storing computer-executable instructions that, when executed with one or more processors of a user device, causes the one or more processors to:
receive, from a user device, an identifier of an accessory device of a plurality of accessory devices and a request to connect with the accessory device, the request received by the computing system via a first network, connectivity between the user device and the plurality of accessory devices via the first network being restricted by a security mechanism of a second network;
transmit a message to a management system of the second network to configure the security mechanism to permit connectivity between the user device and the accessory device based at least in part on the request and the identity of the accessory device;
receive, a message from the management system indicating that the management system has changed a configuration of the security mechanism to permit connectivity between the user device and the accessory device; and
transmit, to the user device and the accessory device, connectivity information for establishing a connection between the user device and the identified accessory device.

11. The computing system of claim 10, wherein the instructions that, when executed by the one or more processors, further cause the one or more processors to validate the user device in response to receiving the request, wherein transmitting the message to the management system is based at least in part on the validation.

12. The computing system of claim 10, wherein the request comprises private key information for establishing a secure connection between the user device and the computing system.

13. The computing system of claim 12, wherein the private key information comprises a transport layer security (TLS) key and a transport layer security (TLS) key identity.

14. The computing system of claim 10, wherein the computing system is connected to the user device via a first network separate from the second network.

15. The computing system of claim 10, wherein the security mechanism comprises a firewall configured to restrict connectivity via the first network between the user device and the identified accessory device.

16. The computing system of claim 10, wherein the identified accessory device is a first accessory device arranged in a defined space, wherein a second accessory device of the plurality of accessory devices is arranged in the defined space, and wherein the management system changes management system has further changed the configuration of the security mechanism to permit connectivity between the user device and the second accessory device.

17. The computing system of claim 16, wherein the defined space is a room or a set of rooms in a building.

18. The computing system of claim 16, wherein an access point is arranged in the defined space, and wherein the user device communicates with the computing system via the access point.

19. One or more non-transitory computer-readable media storing computer-executable instructions that, when executed with one or more processors of a user device, causes a computing system to:
receive, from a user device, an identifier of an accessory device of a plurality of accessory devices and a request to connect with the accessory device, the request received by the computing system via a first network, connectivity between the user device and the plurality of accessory devices via the first network being restricted by a security mechanism of a second network;
transmit a message to a management system of the second network to configure the security mechanism to permit connectivity between the user device and the accessory device based at least in part on the request and the identity of the accessory device;
receive, a message from the management system indicating that the management system has changed a configuration of the security mechanism to permit connectivity between the user device and the accessory device; and
transmit, to the user device and the accessory device, connectivity information for establishing a connection between the user device and the identified accessory device.

20. The one or more non-transitory computer-readable media of claim 19, wherein the instructions that, when executed by the one or more processors, further cause the computing system to validate the user device in response to receiving the request, wherein transmitting the message to the management system is based at least in part on the validation.
